(19) United States
(12) Patent Application Publication
(10) Pub. No.: US 2025/0286671 A1
(43) Pub. Date: Sep. 11, 2025

(54) RESOURCE CONFIGURATION METHOD, RESOURCE DETERMINING METHOD AND APPARATUS, COMMUNICATION DEVICE, AND STORAGE MEDIUM

(71) Applicant: VIVO MOBILE COMMUNICATION CO., LTD., Dongguan (CN)

(72) Inventors: Jianzhi LI, Dongguan (CN); Jianming WU, Dongguan (CN); Dajie JIANG, Dongguan (CN)

(21) Appl. No.: 19/218,357

(22) Filed: May 25, 2025

Related U.S. Application Data
(63) Continuation of application No. PCT/CN2023/132214, filed on Nov. 17, 2023.

(30) Foreign Application Priority Data
Nov. 24, 2022 (CN) 202211486613.1

(51) Int. Cl. H04L 5/00; H04J 13/00; H04W 72/53; H04W 72/542

(52) U.S. Cl. CPC H04L 5/0005; H04W 72/53; H04W 72/542; H04J 13/0025; H04J 13/0029; H04J 13/0062

(57) ABSTRACT

This application discloses a resource configuration method, a resource determining method and apparatus, a communication device, and a storage medium, and belongs to the field of communication technologies. The resource configuration method in embodiments of this application includes: configuring, by a signal sending node, a first resource based on a predetermined first array, where the first array includes at least one Costas array or at least one Costas array set, and each Costas array set includes at least one Costas array; and sending, by the signal sending node, a first signal by using the first resource.

### CROSS-REFERENCE TO RELATED APPLICATIONS

This application is a continuation of International Patent Application No. PCT/CN2023/132214, filed on Nov. 17, 2023, which claims priority to Chinese Patent Application No. 202211486613.1 filed in China on Nov. 24, 2022, both of which are incorporated herein by reference in their entireties.

### TECHNICAL FIELD

This application belongs to the field of communication sensing technologies, and specifically relates to a resource configuration method, a resource determining method and apparatus, a communication device, and a storage medium.

### BACKGROUND

Integrated sensing and communication (integrated sensing and communication, ISAC) has a potential to integrate wireless sensing into a mobile network (which may be referred to as a perceptive mobile network (perceptive mobile network, PMN). A perceptive mobile network is capable of providing both communication and wireless sensing services, has the potential to become a ubiquitous wireless sensing solution due to its large broadband coverage and robust infrastructure, and can be widely used in communication and sensing in the fields of transportation, communication, energy, precision agriculture, and security.

In the related art, a common radar signal, for example, a linear frequency modulation (linear frequency modulation, LFM) signal, has a coupling between a Doppler frequency shift and a distance. When a Doppler frequency shift of a target echo is large, a large ranging error is generated. A sidelobe level of an autocorrelation function of a nonlinear frequency modulation signal (Non LFM, NLFM) is improved, but there is still a large range sidelobe on a high Doppler frequency section of an ambiguity function. A sidelobe of a large target or clutter covers a mainlobe of a small target near the sidelobe. In a multi-target environment, synthesis of a plurality of sidelobes of a target response may even cover a mainlobe of a stronger target response.

### SUMMARY

Embodiments of this application provide a resource configuration method, a resource determining method and apparatus, a communication device, and a storage medium.

According to a first aspect, a resource configuration method is provided. The method includes:
configuring, by a signal sending node, a first resource based on a predetermined first array, where the first array includes at least one Costas array or at least one Costas array set, and each Costas array set includes at least one Costas array; and
sending, by the signal sending node, a first signal by using the first resource.

According to a second aspect, a resource configuration apparatus is provided, used for a signal sending node. The apparatus includes:
a configuration module, adapted to configure a first resource based on a predetermined first array, where the first array includes at least one Costas array or at least one Costas array set, and each Costas array set includes at least one Costas array; and
a sending module, adapted to send a first signal by using the first resource.

According to a third aspect, a resource determining method is provided. The method includes:
determining, by a signal receiving node, a first resource based on a predetermined first array, where the first array includes at least one Costas array or at least one Costas array set, and each Costas array set includes at least one Costas array; and
receiving, by the signal receiving node, a first signal by using the first resource.

According to a fourth aspect, a resource determining apparatus is provided, used for a signal receiving node. The apparatus includes:
a determining module, adapted to determine a first resource based on a predetermined first array, where the first array includes at least one Costas array or at least one Costas array set, and each Costas array set includes at least one Costas array; and
a first receiving module, adapted to receive a first signal by using the first resource.

According to a fifth aspect, a communication device is provided. The communication device includes a processor and a memory. The memory stores a program or instructions runnable on the processor. The program or the instructions, when executed by the processor, implement the steps of the resource configuration method according to the first aspect, or implement the steps of the resource determining method according to the third aspect.

According to a sixth aspect, a signal sending node is provided. The signal sending node includes a processor and a communication interface. The processor is adapted to configure a first resource based on a predetermined first array, where the first array includes at least one Costas array or at least one Costas array set, and each Costas array set includes at least one Costas array. The communication interface is adapted to send a first signal by using the first resource.

According to a seventh aspect, a signal receiving node is provided, including a processor and a communication interface. The processor is adapted to determine a first resource based on a predetermined first array, where the first array includes at least one Costas array or at least one Costas array set, and each Costas array set includes at least one Costas array. The communication interface is adapted to receive a first signal by using the first resource.

According to an eighth aspect, a communication system is provided. The communication system includes: a signal sending node and a signal receiving node. The signal sending node may be adapted to perform the steps of the resource configuration method according to the first aspect, and the signal receiving node may be adapted to perform the steps of the resource determining method according to the third aspect.

According to a ninth aspect, a readable storage medium is provided. The readable storage medium stores a program or instructions, and the program or the instructions, when executed by a processor, implement the steps of the resource configuration method according to the first aspect, or implement the steps of the resource determining method according to the third aspect.

According to a tenth aspect, a chip is provided, including a processor and a communication interface. The communication interface is coupled to the processor, and the processor is adapted to execute a program or instructions, to implement the steps of the resource configuration method according to the first aspect, or implement the steps of the resource determining method according to the third aspect.

According to an eleventh aspect, a computer program/program product is provided. The computer program/program product is stored in a storage medium. The computer program/program product is executed by at least one processor, to implement the steps of the resource configuration method according to the first aspect, or implement the steps of the resource determining method according to the third aspect.

In the embodiments of this application, a signal sending node configures a first resource based on a predetermined first array. The first array includes at least one Costas array or at least one Costas array set, and each Costas array set includes at least one Costas array. The signal sending node sends a first signal by using the first resource. Because a Costas array has a special sequence structure, and Costas arrays of different orders all have a “pin-shaped” ambiguity function, a resource sequence of a first resource configured based on the Costas array also has a “pin-shaped” ambiguity function.

### BRIEF DESCRIPTION OF THE DRAWINGS

FIG. 1 is a schematic structural diagram of a network to which an embodiment of this application is applicable;

FIG. 2 is a flowchart of a resource configuration method according to an embodiment of this application;

FIG. 3a is a schematic diagram of a time-frequency resource of a Costas array of order 6 according to an embodiment of this application;

FIG. 3b is a schematic diagram of a time-frequency resource of a Costas array of order 12 according to an embodiment of this application;

FIG. 4 is a schematic diagram of RRC configuration of a time-frequency resource of a CSI-RS according to an embodiment of this application;

FIG. 5 is a schematic diagram of physical resource configuration of a CSI-RS according to an embodiment of this application;

FIG. 6 is a schematic diagram of slot resource configuration of a periodic CSI-RS according to an embodiment of this application;

FIG. 7a is a flowchart of signal configuration of a periodic CSI-RS according to an embodiment of this application;

FIG. 7b is a flowchart of signal configuration of an aperiodic CSI-RS according to an embodiment of this application;

FIG. 8a is a schematic diagram 1 of a time-frequency resource of a Costas array configured based on a CSI-RS according to an embodiment of this application;

FIG. 8b is a schematic diagram 2 of a time-frequency resource of a Costas array configured based on a CSI-RS according to an embodiment of this application;

FIG. 9 is a schematic diagram of a mapping relationship of a resource of a Costas array across RBs and slots in OFDM according to an embodiment of this application;

FIG. 10 is a structural diagram of a resource configuration apparatus according to an embodiment of this application;

FIG. 11 is a flowchart of a resource determining method according to an embodiment of this application;

FIG. 12 is a structural diagram of a resource determining apparatus according to an embodiment of this application;

FIG. 13 is a structural diagram of a communication device according to an embodiment of this application;

FIG. 14 is a structural diagram of a terminal according to an embodiment of this application;

FIG. 15 is a structural diagram of a network side device according to an embodiment of this application; and

FIG. 16 is a structural diagram of another network side device according to an embodiment of this application.

### DETAILED DESCRIPTION

The technical solutions in the embodiments of this application are clearly described in the following with reference to the accompanying drawings in the embodiments of this application. Apparently, the described embodiments are merely some rather than all of the embodiments of this application. Based on the embodiments of this application, all other embodiments obtained by a person of ordinary skill in the art fall within the protection scope of this application.

Terms such as “first” and “second” in the specification and claims of this application are used to distinguish between similar objects, but are not used to describe a specific sequence or order. It should be understood that the terms used in this way are exchangeable in a proper case, so that the embodiments of this application can be implemented in an order other than the order shown or described herein, and objects distinguished by “first” and “second” are usually of a type and a quantity of the objects is not limited. For example, there may be one or more first objects. In addition, in the specification and claims, “and/or” represents at least one of the connected objects, and a character “/” generally indicates an “or” relationship between the associated objects.

It should be noted that technologies described in the embodiments of this application are not limited to a long term evolution (Long Term Evolution, LTE)/LTE-advanced (LTE-Advanced, LTE-A) system, and may be further used in other wireless communication systems, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), and other systems. The terms “system” and “network” in the embodiments of this application are usually interchangeably used, and the technologies described may be applied to the systems and radio technologies mentioned above, and may also be applied to other systems and radio technologies. The following descriptions describe a new radio (New Radio, NR) system for an example purpose, and NR terms are used in most of the following descriptions. However, these technologies may also be applied to an application other than an NR system application, such as a 6th Generation (6th Generation, 6G) communication system.

FIG. 1 is a block diagram of a radio communication system to which an embodiment of this application is applicable. The wireless communication system includes a terminal 11 and a network side device 12. The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palm computer, a netbook, an ultra-mobile personal computer (ultra-mobile personal computer, UMPC), a mobile Internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), smart home (home devices with a wireless communication function, such as a refrigerator, a television, a washing machine, or furniture), a game machine, a personal computer (personal computer, PC), a teller machine or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wrist strap, a smart dress, and the like. It should be noted that a specific type of the terminal 11 is not limited in the embodiments of this application. The network side device 12 may include an access network device or a core network node. The access network device may also be referred to as a radio access network device, a radio access network (Radio Access Network, RAN), a radio access network function, or a radio access network unit. The access network device may include a base station, a wireless local area network (Wireless Local Area Network, WLAN) access point or a Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmission reception point (Transmission Reception Point, TRP), or another appropriate term in the art. The base station is not limited to a specific technical term, provided that a same technical effect is achieved. It should be noted that, the base station in the NR system is used only as an example for description in the embodiments of this application, but a specific type of the base station is not limited. The core network node may include, but is not limited to, at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF), an edge application server discovery function (Edge Application Server Discovery Function, EASDF), unified data management (Unified Data Management, UDM), unified data repository (Unified Data Repository, UDR), a home subscriber server (Home Subscriber Server, HSS), centralized network configuration (Centralized network configuration, CNC), a network repository function (Network Repository Function, NRF), network exposure functions (Network Exposure Function, NEF), a local NEF (Local NEF, or L-NEF), a binding support function (Binding Support Function, BSF), an application function (Application Function, AF), or the like. It should be noted that in the embodiments of this application, the core network node in the NR system is only used as an example, but a specific type of the core network node is not limited.

This application relates to an integrated sensing and communication (Integrated Sensing and Communication, ISAC) technology. Related descriptions of the integrated sensing and communication technology is first provided below.

Wireless communication and radar sensing (Communication&Sensing, C&S) have been developing in parallel, but an intersection of the wireless communication and the radar sensing is limited. The wireless communication and the radar sensing have many commonalities in signal processing algorithms, devices, and system architecture to some extent. In recent years, a conventional radar is developing toward a more universal direction of wireless sensing. Wireless sensing may extensively refer to retrieving information from received radio signals. For wireless sensing related to sensing a target location, dynamical parameters such as a reflection delay, an angle of arrival, an angle of departure or a Doppler parameter of a target signal may be estimated in a common signal processing method. Sensing a target physical feature may be implemented by measuring an intrinsic signal mode of a device, an object, or an activity. The two sensing modes may be respectively referred to as sensing parameter estimation and mode recognition. In this sense, wireless sensing refers to a more universal sensing technology and application using radio signals.

Integrated sensing and communication (Integrated Sensing and Communication, ISAC) has a potential to integrate the wireless sensing into a large-scale mobile network, which is referred to as a perceptive mobile network (Perceptive Mobile Network, PMN). The perceptive mobile network can provide both communication and wireless sensing services, and has a potential to become a ubiquitous wireless sensing solution due to a large broadband coverage and robust infrastructure. The perceptive mobile network can be widely applied to communication and sensing in transportation, communication, energy, precision agriculture, and security fields. The perceptive mobile network may further provide a complementary sensing capacity for an existing sensor network, has a unique operation function day and night, and can penetrate through fog, leaves, and even solid subjects. Some common sensing services are shown in Table 1 below:

TABLE 1

| | Real-time | | |
|---|---|---|---|
| Physical | performance | | |
| range of | requirement of | | |
| sensing | sensing | Sensing function | Application purpose |
| Large | Medium | Weather, air quality, and the like | Meteorology, agriculture, and |
| | | | life services |
| Large | Medium | Vehicle flow (road) and people | Smart city, intelligent |
| | | flow (metro station) | transportation, and commercial |
| | | | service |
| Large | Medium | Animal activity, migration, and | Animal husbandry, ecological |
| | | the like | environmental protection, and |
| | | | the like |
| Large | High | Target tracing, distance | Many application scenarios of a |
| | | measurement, speed | conventional radar and V2X |
| | | measurement, and angle | |
| | | measurement | |
| Large | Low | Three-dimensional map | Navigation and smart city |
| | | construction | |
| Small | High | Motion and posture recognition | Intelligent interaction, gaming, |
| | | | and smart home through smart |
| | | | phones |
| Small | High | Heartbeat/respiration and the | Health supervision and medical |
| | | like | treatment |
| Small | Medium | Imaging | Security check and logistics |
| Small | Low | Material | Construction, manufacturing, |
| | | | exploration, and the like |

In a mobile communication network, a base station (including one or more TRPs on the base station, a user equipment (User Equipment, UE, or a “terminal”) (including one or more antenna sub-arrays/panels (Panels) on the UE)) may serve as a sensing node participating in a sensing or an ISAC service. An area or a physical target may be sensed by sending and receiving a sensing signal sensing node. The sensing signal may be a signal that does not include transmission information, for example, existing LTE/NR synchronization and reference signals (including a synchronization signal and physical broadcast channel (Synchronization Signal and PBCH block, SSB) signal, a channel state information (Channel State Information, CSI) reference signal (CSI Reference Signal, CSI-RS), a demodulation reference signal (Demodulation Reference Signal, DMRS), a channel sounding reference signal (Sounding Reference Signal, SRS), a positioning reference signal (Positioning Reference Signal, PRS), and a phase-tracking reference signal (Phase-Tracking Reference Signal, PTRS), and the like), or may be a continuous wave (Continuous Wave, CW), a frequency modulated continuous wave (Frequency Modulated CW, FMCW), an ultra-wideband Gaussian pulse, and the like commonly used for a radar. In addition, the sensing signal may alternatively be a newly designed dedicated sensing signal, which has good correlation property and a low peak-to-average power ratio (Peak-to-Average Power Ratio, PAPR), or a newly designed integrated sensing and communication signal, which carries information and has good sensing performance. A type of the sensing signal is not specifically limited herein. The first signal involved in this application may include any one of the foregoing sensing signals, or may include a non-sensing signal such as a communication signal.

In the embodiments of this application, the signal sending node and the signal receiving node may be a same device or different devices. For example, a sensing node A sends a first signal, a sensing node B receives the first signal, and the sensing node A and the sensing node B are not a same device and are separated in physical locations; or a sensing node A sends and receives a first signal, in other words, the sensing signal is sent and received by a same device, and the sensing node senses by receiving a signal echo sent by the sensing node. For ease of description, in the embodiments of this application, that the signal sending node and the signal receiving node are different devices is used as an example for description. This is not specifically limited herein.

Design of a sensing/integrated sensing and communication signal is a focus of research on the integrated sensing and communication technology. A distance resolution and a speed (radial) resolution of the sensing/integrated sensing and communication signal depend on a selected signal form. A wider frequency band occupied by the sensing/integrated sensing and communication signal in a frequency domain indicates a better distance resolution. A larger continuous width of the sensing/integrated sensing and communication signal in a time domain indicates a better speed resolution. To design the sensing/integrated sensing and communication signal from a perspective of improving sensing or a resolution, it is required that a main peak of an ambiguity function of the sensing/integrated sensing and communication signal is high and sharp, and a sub-peak is low and flat. In the related art, a radar signal, for example, a linear frequency modulation (Linear Frequency Modulation, LFM) signal, has a coupling between a Doppler frequency shift and a distance. When a Doppler frequency shift of a target echo is large, a large ranging error is generated. A sidelobe level of an autocorrelation function of a nonlinear frequency modulation signal (Non LFM, NLFM) is improved, but there is still a large range sidelobe on a high Doppler frequency section of an ambiguity function. A sidelobe of a large target or clutter covers a mainlobe of a small target near the sidelobe. In a multi-target environment, synthesis of a plurality of sidelobes of a target response may even cover a mainlobe of a stronger target response. It can be learned that there is a problem in the related art that signal sensing performance is poor. If a signal form of a radar signal in the related art is applied to a sensing signal, the signal sensing performance is caused to be poor.

In the embodiments of this application, a first resource is configured through a Costas array, and a first signal is sent by using the first resource. Because a Costas array has a special sequence structure, and Costas arrays of different orders all have a “pin-shaped” ambiguity function, a resource sequence of a first resource configured based on the Costas array also has a “pin-shaped” ambiguity function. The first signal is sent by using the first resource, so that a main peak of the first signal is high and sharp, a sub-peak is low and flat, and a signal resolution is high. It can be learned that signal sensing performance can be improved according to this embodiment of this application.

The following briefly describes a Costas array:

It is set that P is a permutation matrix of order n, in the matrix, a column (in a direction of a horizontal axis) represents time, a row (in a direction of a vertical axis) represents frequency, and a row index sequence of a matrix element “1” (which is a frequency hopping signal sequence) is also referred to as a sequence P. If a maximum value of a sidelobe of a (discrete) autocorrection function R(τ,d) of the sequence P is not greater than 1, the permutation matrix P is referred to as a Costas array (Costas Array) of order n, and the sequence P is referred to as a Costas sequence. Generally, {c₁, c₂, . . . , cₙ} is used for representing the sequence P. In this application, the “Costas array” is equivalent to the “Costas sequence”, and only names are different. The “array” is named from a perspective of a time-frequency two-dimensional resource grid, and the “sequence” is named from a perspective of a signal. The Costas sequence has a special sequence structure, leading to that the Costas sequence has theoretically optimal ambiguity function performance, that is, an ambiguity function pattern has a “pin-shaped” feature.

A Costas array of order n has a limited quantity. The Costas array can be rapidly constructed through a finite field theory. In abstract algebra, a “field” is a set (an algebraic structure) on which operations of adding, subtracting, multiplying, and dividing can be performed, and a result does not exceed the set, and a concept of the field is promotion of a number field and four arithmetic operations. If a field F includes only finite elements, the field F is referred to as a “finite field” (GF). GF is an abbreviation of a Galois Field. Therefore, the finite field may also be referred to as a “Galois Field”.

Manner 1: The following several types of Costas arrays may be constructed by using a formula method:

### (1) Welch-Costas Array

Assuming a finite field GF(l), l being a prime number, α being a primitive element (Primitive Element) of GF(l), n being a non-zero element (Non-zero Element) of GF(l), and the sequence P being a permutation matrix of order (l−1), a sufficient condition for the sequence P to be the Costas sequence is that a placement function of the sequence P is:

$$y ( k ) ≡ {ηα}^{k} ( mod l ) , 1 \leq k \leq l - 1 \qquad ( 1 )$$

Such an array is referred to as a Welch-Costas array. The Welch-Costas sequence uses l−1 as a cycle period in a horizontal direction, and uses l as a cycle period in a vertical direction.

Explanation of the primitive element is as follows: an order of a under a modulo n is m=phi(n), where a is a primitive element of n; and the primitive element is not unique.

Explanation of the concept of order is as follow: a quantity of elements in the finite field is referred to as an “order” of the finite field.

Explanation of an Euler function is as follows: phi(x) is the Euler function, and a value of phi(x) is a quantity of non-zero positive integers that are less than n and that are co-prime with n. For example, phi(8)=4 (1, 3, 5, 7); and if n is a prime number, phi(n)=n−1. For example, phi(7)=6 (1, 2, 3, 4, 5, 6).

A sequence represented by equation (1) may be considered as being obtained by performing cyclic shift on a sequence represented by equation (2) in the horizontal direction, where equation (2) is:

$$y ( k ) ≡ {α}^{k} ( mod l ) , 1 \leq k \leq l - 1 \qquad ( 2 )$$

That is, η is 1. The Welch-Costas constructed by using equation (2) is also referred to as exponential (Exponential) Welch-Costas. An inverse function of equation (2) is defined as follows:

$$y ( k ) ≡ {log}_{α} k ( mod l - 1 ) , 0 \leq k \leq l - 1 \qquad ( 3 )$$

It may be understood that the Costas array may also be constructed by using equation (3), and Welch-Costas obtained in this manner is also referred to as a logarithmic (Logarithmic) Welch-Costas.

### (2) Golomb-Costas Array

Assuming a finite field GF(q), where q=l^{α}, l is a prime number, and x is a positive integer. α, β are primitive elements of GF(q), and a sufficient condition for the sequence P to be a Golomb-Costas sequence is that a placement function of the sequence P is

$$y ( k ) ≡ {log}_{β} ( 1 - {a}^{k} ) ( mod f ( x ) ) , 0 \leq k \leq q - 2 \qquad ( 4 )$$

f(x) is any irreducible polynomial of degree x over a field of a congruence class Zᵢ of an integer modulo 1 [3], [4]. The foregoing formula is: If coordinates of a unit grid of the sequence P are set to (i, j), when αⁱ+βⁱ≡1(mod f(x)), “1” is placed in the unit grid. A Costas array having such a structure is referred to as a Golomb-Costas array.

### (3) Lempel-Costas Array

If α=β is set, an array obtained through equation (5) is referred to as a Lempel-Costas array.

$$y ( k ) ≡ {log}_{α} ( 1 - {a}^{k} ) ( mod f ( x ) ) , 0 \leq k \leq q - 2 \qquad ( 5 )$$

Manner 2: The Costas array may alternatively be obtained by using a geometrical construction method.

A directed line segment connecting two “1” unit grids of a replacement sequence P is referred to as a vector of the sequence P. Apparently, the sequence P has in total n(n−1)/2 vectors. If any two vectors of P are different, in other words, lengths and directions of the two vectors are not the same at the same time (where the directions being the same herein means that the two vectors are in parallel), the sequence P is the Costas sequence.

Manner 3: The Costas array may alternatively be obtained through searching by using a method of exhaustion.

A Costas sequence is searched in n! permutation matrices of order n. A method of calculating a check matrix (Check Matrix) of the permutation matrix may be used for the search. To reduce calculation workload, calculation may be simplified by using a property of the check matrix. When n>25, a quantity of Costas sequences is significantly reduced. Specially, when n tends to infinity, the quantity of Costas sequences tends to 0. It cannot be answered what condition that n satisfies so that there is no Costas sequence, but when n=32, 33, or 43, there is no Costas sequence. Table 6 shows 25 Costas arrays of order n=24, where each row corresponds to one Costas sequence. There are 25 rows in total, and a quantity of elements in each row is 24.

It should be noted that another three different Costas arrays can be obtained by horizontally flipping, vertically flipping, or simultaneously horizontally and vertically flipping one Costas array. Further, if an original Costas array is not symmetrical with respect to a diagonal/an anti-diagonal, another four Costas arrays can be obtained by rotating clockwise/anticlockwise with reference to the foregoing flipping. That is, after one Costas array is constructed, four or eight Costas arrays are actually obtained. None of the Costas arrays of order 24 shown in Table 6 is a symmetrical array. Therefore, 25×8-200 Costas arrays of order 24 may be actually obtained.

For ease of better understanding of the embodiments of this application, the following references are provided:
[1] Rahman, Md Lushanur, et al. “Enabling joint communication and radio sensing in mobile networks—a survey.” arXiv preprint arXiv: 2006.07559 (2020).
[2] Costas, John P. “A study of a class of detection waveforms having nearly ideal range—Doppler ambiguity properties.” Proceedings of the IEEE 72.8 (1984): 996-1009.
[3] Yao Jianguo. “A Study for the Application of Costas Arrays in Radar Signal Design.” Electronic Engineer 33.5 (2007): 1-6.
[4] Golomb, Solomon W., and Herbert Taylor. “Constructions and properties of Costas arrays.” Proceedings of the IEEE 72.9 (1984): 1143-1163.
[5] Yao Jianguo, and Huang Qing. “Study on the Application of Costas Arrays to Multiple Targets Scattering Radar Systems.” Journal of Nanjing University of Posts and Telecommunications: National Science Edition 30.4 (2010): 61-70.
[6] Beard, James K., et al. “Combinatoric collaboration on Costas arrays and radar applications.” Proceedings of the 2004 IEEE Radar Conference (IEEE Cat. No. 04CH37509). IEEE, 2004.
[7] Costas Arrays to Order 1030, IEEE DataPort Database, DOI: http://dx.doi.org/10.21227/H21P42.

The following describes in detail a resource configuration method, a resource determining method and apparatus, a communication device, and a storage medium provided in the embodiments of this application by using some embodiments and application scenarios thereof with reference to the accompanying drawings.

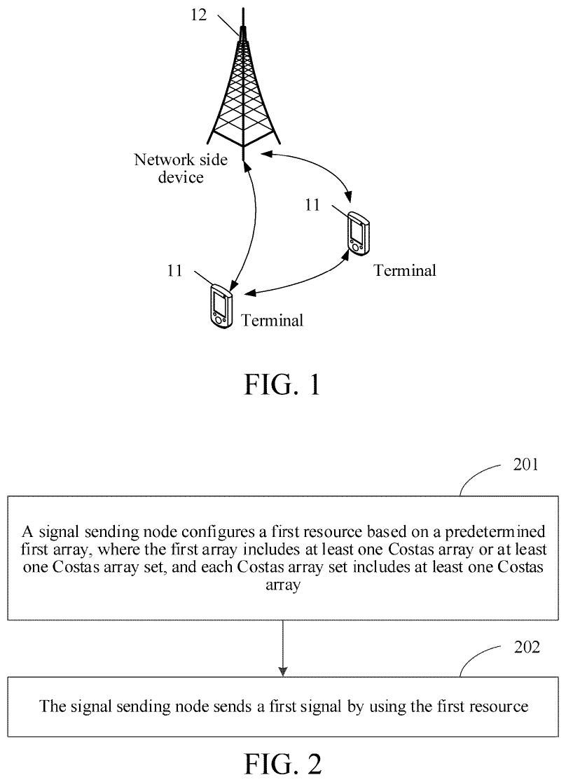

FIG. 2 is a flowchart of a resource configuration method according to an embodiment of this application. As shown in FIG. 2, the resource configuration method includes the following steps.
Step 201: A signal sending node configures a first resource based on a predetermined first array, where the first array includes at least one Costas array or at least one Costas array set, and each Costas array set includes at least one Costas array.
Step 202: The signal sending node sends a first signal by using the first resource.

In this embodiment of this application, the signal sending node may be a terminal, or may be a network side device. This is not specifically limited herein. The first signal may be a signal related to a sensing service or an integrated sensing and communication service (which is collectively referred to as a sensing signal), or may be a non-sensing signal such as a communication signal. This is not specifically limited herein. For ease of understanding and description, this embodiment of this application is generally described by using an example in which the first signal is a sensing signal.

The first resource is a resource to which the first array is mapped, and the first array includes at least one Costas array or at least one Costas array set. Therefore, the essence of the first array is a Costas array, that is, the essence of the first resource is a Costas array resource. The first resource is used for transmitting a first signal. When the first signal is a sensing signal, the first resource may be referred to as a sensing resource or a sensing signal resource, and the first signal may be referred to as a Costas sensing signal. The first resource may be a signal sensing resource used by at least one antenna port of the signal sending node. In other words, a Costas array may be used for the signal sensing resource of the at least one antenna port of the signal sending node.

A basic unit of the first resource may be one resource element (Resource Element, RE) in a time-frequency domain in an NR orthogonal frequency division multiplex (Orthogonal frequency division multiplexing, OFDM) system, that is, a time-frequency resource grid.

It should be noted that a design scheme of the first resource in this embodiment of this application is also applicable to using at least one consecutive resource block (Resource Block, RB) in a frequency domain and/or at least one consecutive slot (namely, a slot, including 14 OFDM symbols) in a time domain as the basic unit. In addition, the sensing signal resource may be further allocated within the RB and the slot.

It should be further noted that the basic units of the first resource to which the first array is mapped may be spaced apart in the frequency domain and/or the time domain, that is, the basic units of the first resource may be inconsecutive in the frequency domain and/or the time domain.

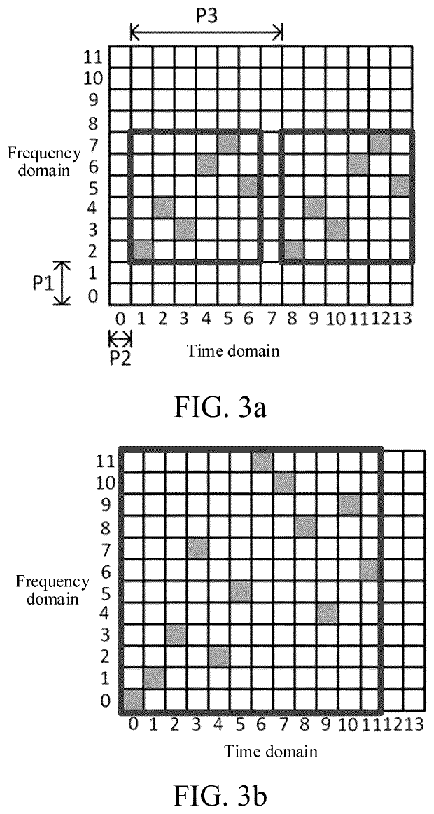

For ease of description, in this embodiment of this application, an example in which an RE is a basic unit of a first resource is used for description. In an example, FIG. 3a and FIG. 3b provide schematic diagrams of resource mapping relationships of two Costas arrays in the OFDM. FIG. 3a shows two Costas arrays, orders of the two Costas arrays are both 6, and FIG. 3b shows one Costas array, and an order of the Costas array is 12. In all examples in this embodiment of this application, it is default that sub-carrier indexes in one RB are 0 to 11, and OFDM symbol indexes in one slot (Slot) are 0 to 13. Using FIG. 3a as an example, a Costas sequence may be represented as {0, 2, 1, 4, 5, 3}. Herein, the sequence merely reflects a relative frequency hopping sequence of a signal. For one Costas array, after a sub-carrier index and an OFDM symbol index corresponding to any element in the Costas array are determined (for example, 0 corresponds to the sub-carrier index 2 and the OFDM symbol index 1), sub-carrier indexes and OFDM symbol indexes corresponding to all other elements of the Costas array are determined accordingly. In other words, after a time-frequency position of any element of one provided Costas array is determined, time-frequency positions of all Costas array elements are also determined.

In this embodiment of this application, because a Costas array has a special sequence structure, and Costas arrays of different orders all have a “pin-shaped” ambiguity function, a resource sequence of a first resource configured based on the Costas array also has a “pin-shaped” ambiguity function. The first signal is sent by using the first resource, so that a main peak of the first signal is high and sharp, a sub-peak is low and flat, and a signal resolution is high. It can be learned that signal sensing performance can be improved according to this embodiment of this application.

In this embodiment of this application, a quantity of Costas arrays in the first array may be greater than 1. That is, a quantity of Costas arrays in a range of available frequency domain resources may be greater than 1, and/or a quantity of Costas arrays in a range of available time domain resources may be greater than 1. In this embodiment of this application, a set formed by a plurality of Costas arrays may be referred to as a Costas array set.

In some embodiments, in a case in which the first array includes at least two Costas arrays or includes at least two Costas array sets, the first array includes at least one of the following:
at least two Costas arrays arranged at an interval in a frequency domain;
at least two Costas arrays arranged at an interval in a time domain;
at least two Costas array sets arranged at an interval in the frequency domain; and
at least two Costas array sets arranged at an interval in the time domain.

For example, FIG. 3a shows two Costas arrays arranged at an interval in a time domain, and orders of the two Costas arrays are both 6.

It should be noted that an interval between any two adjacent Costas arrays or Costas array sets may be the same or different, and the interval between the two adjacent Costas arrays or the Costas array sets may be determined by a configuration parameter related to a position of each Costas array or Costas array set in an available time-frequency resource.

In some embodiments, the at least two Costas arrays have a same order and structure; or
the at least two Costas arrays have a same order and different structures; or
the at least two Costas arrays have different orders and structures.

The first array may be predetermined by the signal sending node. In other words, before the signal sending node configures the first resource based on the predetermined first array, the method may further include:
the signal sending node determines the first array.

In some embodiments, that the signal sending node determines the first array includes:
the signal sending node determines a structure of the first array and a position of a time-frequency resource to which the first array is mapped.

The structure of the first array is, for example, an order of a Costas array and a type of the Costas array. The type of the Costas array may include at least one of a Welch-Costas array, a Golomb-Costas array, and a Lempel-Costas array. Once the structure of the first array is determined, a relative position of a time-frequency resource element to which the first array is mapped is determined. The position of the time-frequency resource to which the first array is mapped is, for example, a position of the Costas array in the available time-frequency resource.

Once the structure of the first array and the position of the time-frequency resource to which the first array is mapped are determined, an absolute position of the time-frequency resource to which the first array is mapped is determined, and the signal sending node may configure the first resource based on the absolute position of the time-frequency resource to which the first array is mapped.

There are a plurality of solutions for determining the structure of the first array. The following describes the solution for determining the structure of the first array.

In some embodiments, that the signal sending node determines a structure of the first array includes any one of the following:
the signal sending node determines the structure of the first array based on an algebraic construction method; or
the signal sending node determines the structure of the first array based on a look-up table method.

Solution 1: The signal sending node determines the structure of the first array based on an algebraic construction method.

The algebraic construction method may include a formula construction method and a geometrical construction method. For example, a method for determining the structure of the Costas array may be an algebraic construction method based on at least one of the Welch-Costas array, the Golomb-Costas array, and the Lempel-Costas array. In other words, the structure of the Costas array is obtained through calculation by using a placement function formula (namely, at least one of formula (1) to formula (5)) corresponding to the foregoing various types of Costas arrays. For example, formula (2) is a placement function of the Welch-Costas array. In this way, the Costas array shown in FIG. 3b is generated. Primitive elements of GF(13) are 2, 6, 7, and 11, and assuming that 1=13, α=2, and η=7 herein, a generated Costas sequence is:

$$\{ {c}_{1} , {c}_{2} , … , {c}_{12} \} = \{ 7 \cdot {2}^{1} mod 13 - 1 , 7 \cdot {2}^{2} mod 13 - 1 , 7 \cdot {2}^{3} mod 13 - 1 , 7 \cdot {2}^{4} mod 13 - 1 , 7 \cdot {2}^{5} mod 13 - 1 , 7 \cdot {2}^{6} mod 13 - 1 , 7 \cdot {2}^{7} mod 13 - 1 , 7 \cdot {2}^{8} mod 13 - 1 , 7 \cdot {2}^{9} mod 13 - 1 , 7 \cdot {2}^{10} mod 13 - 1 , 7 \cdot {2}^{11} mod 13 - 1 , 7 \cdot {2}^{12} mod 13 - 1 \} = \{ 0 , 1 , 3 , 7 , 2 , 5 , 11 , 10 , 8 , 4 , 9 , 6 \} \qquad ( 6 )$$

It should be noted that the foregoing sequence determines only the structure of the Costas array, that is, a relative position of a time-frequency resource element of the sensing signal.

Solution 2: The signal sending node determines the structure of the first array based on a look-up table method.

The look-up table method is selecting at least one Costas array from a limited quantity of Costas array sets that are agreed in advance. The Costas array may be indicated to at least one of a transmitter (namely, the signal sending node) and a receiver (namely, a signal receiving node) in a sensing system or an integrated sensing and communication system by using a Costas array set index and/or a Costas array index that is agreed in advance.

In some embodiments, that the signal sending node determines a structure of the first array includes:
the signal sending node determines the structure of the first array based on at least one of the following: order indication information of a Costas array, type indication information of a Costas array, a prime number of a Costas array, a primitive element of a finite field of a Costas array, a non-zero element of a finite field of a Costas array, a power of a prime number of a Costas array, resource mapping granularity indication information of a Costas array, a Costas array set index, and a Costas array index.

The type indication information of a Costas array may be used for indicating types such as a Welch-Costas array, a Golomb-Costas array, and a Lempel-Costas array.

In an example, a list of different combinations of parameters, such as a prime number l, a finite field GF(l) (or GF(lm)), a primitive element α (or α and β), and a non-zero element η of a finite field, and a list index corresponding to each combination, used to generate the Costas array may be agreed in advance. The network side device indicates the list index to at least one of the transmitter (namely, the signal sending node) and the receiver (namely, the signal receiving node) in the sensing system or the integrated sensing and communication system. The at least one of the transmitter and the receiver may determine specific values of the foregoing parameters by looking up a table.

In some embodiments, that the signal sending node determines a position of a time-frequency resource to which the first array is mapped includes:
the signal sending node determines, based on a start frequency of the first signal, start time of the first signal, a frequency offset of the first array, and a time offset of the first array, the position of the time-frequency resource to which the first array is mapped.

Herein, the frequency offset of the first array may represent an offset of a start position of the frequency domain of the first array relative to the start frequency of the first signal, and the time offset of the first array may represent an offset of a start position of the time domain of the first array relative to the start time of the first signal.

In some embodiments, that the signal sending node determines the first array includes:
the signal sending node receives first configuration information, where the first configuration information is used for configuring the first signal; and
the signal sending node determines the first array based on the first configuration information.

When the first signal is a sensing signal, the first configuration information may be referred to as sensing signal configuration information. The position of the first array in the available time-frequency resource may be flexibly configured by using the first configuration information.

In some embodiments, the first configuration information includes at least one of the following:
structure indication information of a Costas array;
order indication information of a Costas array;
type indication information of a Costas array;
generation method indication information of a Costas array;
generation parameter indication information of a Costas array;
index indication information of a Costas array;
resource mapping granularity indication information of a Costas array; and
a configuration parameter of a time-frequency resource position of a Costas array.

In some embodiments, the configuration parameter of the time-frequency resource position of the Costas array includes at least one of the following:
a start frequency of the first signal;
start time of the first signal;
a total width of a frequency domain of the first signal;
total duration of the first signal;
a first frequency offset (which may be represented as Frequency Offset 1), used for indicating an offset of a start frequency of a Costas array relative to the start frequency of the first signal;
a first time offset (which may be represented as Time Offset 1), used for indicating an offset of start time of a Costas array relative to the start time of the first signal;
a second frequency offset (which may be represented as Frequency Offset 2), used for indicating an offset of a start frequency of a Costas array set to which a Costas array belongs relative to the start frequency of the first signal;
a second time offset (which may be represented as Time Offset 2), used for indicating an offset of start time of a Costas array set to which a Costas array belongs relative to the start time of the first signal;
a third frequency offset (which may be represented as Frequency Offset 3), used for indicating an offset of a start frequency of a Costas array relative to a start frequency of a Costas array set to which the Costas array belongs;
a third time offset (which may be represented as Time Offset 3), used for indicating an offset of start time of a Costas array relative to start time of a Costas array set to which the Costas array belongs;
a first frequency domain cycle (which may be represented as Frequency Cycle 1), used for indicating a frequency domain interval between adjacent Costas arrays;
a first time domain cycle (which may be represented as Time Cycle 1), used for indicating a time domain interval between adjacent Costas arrays;
a second frequency domain cycle (which may be represented as Frequency Cycle 2), used for indicating a frequency domain interval between adjacent Costas array sets;
a second time domain cycle (which may be represented as Time Cycle 2), used for indicating a time domain interval between adjacent Costas array sets;
a quantity of frequency-domain Costas arrays, used for indicating a quantity of Costas arrays included in each Costas array set in the frequency domain;
a quantity of time-domain Costas arrays, used for indicating a quantity of Costas arrays included in each Costas array set in the time domain;
a quantity of frequency-domain Costas array sets, used for indicating a quantity of Costas array sets in the frequency domain;
a quantity of time-domain Costas array sets, used for indicating a quantity of Costas array sets in the time domain;
a modulation sequence parameter of a Costas array;
a muted time position in a Costas array; and
quasi co-location information between a time-frequency resource in which a Costas array is located and another reference signal.

In some embodiments, the generation parameter indication information includes at least one of the following:
a prime number used for generating a Costas array;
a primitive element of a finite field used for generating a Costas array;
a non-zero element of a finite field used for generating a Costas array; and
a power of a prime number used for generating a Costas array.

The following further provides definitions and explanations of the Costas array-based sensing signal configuration information, and acting objects of the described parameters. In this embodiment of this application, the sensing signal configuration information may include at least one of the following:

Costas signal order: A value of the Costas signal order is equal to a quantity of consecutive resources (sub-carriers, RBs, or the like) to which a single Costas array is mapped in a frequency domain resource span, and is also equal to a quantity of consecutive resources (OFDM symbols, slots, or the like) to which the single Costas array is mapped in a time domain resource span. If a configured sensing signal uses more than one Costas array, the parameter includes more than one parameter value.

Generation method indication of a Costas array: It is used for indicating whether a generation method of a Costas array is a formula generation method or a look-up table generation method. It should be noted herein that alternatively, N array solutions may be agreed on by using a protocol. A network side device notifies, by using signaling, a UE of which array solution is specifically used. In other words, whether a Costas array is generated by using a formula or by looking up a table is not considered in the protocol, and what a specific Costas array is only considered.

Type indication of a Costas array: It indicates at least one of a Welch-Costas array, a Golomb-Costas array, and a Lempel-Costas array.

Prime number l used for generating a Costas array: The parameter is used when a Costas array generation method is the formula generation method, and corresponds to the finite field GF(l) when a Welch-Costas array is generated; and corresponds to the finite field GF(lm) when a Golomb-Costas array and/or a Lempel-Costas array is generated.

Primitive element (α and β) of a finite field used for generating a Costas array: The parameter is used when the Costas array generation method is the formula generation method, and when a Welch-Costas array and/or a Lempel-Costas array is generated, α is a mandatory parameter; and when a Golomb-Costas array is generated, α, and β are mandatory parameters.

Non-zero element (η) of a finite field used for generating a Costas array: The parameter is used when the Costas array generation method is the formula generation method and a Welch-Costas array is generated. Optionally, in an actual application, a value of the parameter may be agreed in advance to be fixed to 1.

Power (m) of a prime number l used for generating a Costas array: The parameter is used when the Costas array generation method is the formula generation method and a Golomb-Costas array or a Lempel-Costas array is generated.

Resource mapping granularity indication information of a Costas array: The parameter is used for indicating a granularity of a mapping unit of a generated Costas array, and may be an RE (for example, a sub-carrier), an RB, a bandwidth part (Bandwidth Part, BWP), or a bandwidth of any pre-defined size in a frequency domain; and may be an OFDM symbol, a slot (slot), an OFDM frame, or a time length of any pre-defined size in a time domain. The mapping unit may be a combination of any of the foregoing frequency domain units and time domain units.

Costas array index: When a Costas array used for constructing a sensing signal/an integrated sensing and communication signal is determined by using the look-up table method, a candidate list of the Costas array may be predefined, and each Costas array corresponds to one list index.

Costas array set index: When a constructed sensing/integrated sensing and communication signal includes more than one Costas array, a candidate list of a Costas array set may be predefined. In other words, each entry in the list corresponds to one Costas array set (including not less than one Costas array), and each Costas array set corresponds to one index. Optionally, Costas arrays in different Costas array sets are different. Optionally, Costas arrays in different Costas array sets may be completely the same, but an arrangement sequence of the Costas arrays in the Costas array sets in a time domain and/or a frequency domain may be different.

Start frequency of a sensing signal/an integrated sensing and communication signal: The parameter defines a lowest frequency position (Lowest Subcarrier) of a sensing signal/an integrated sensing and communication signal, and is also referred to as a frequency reference point.

Start time of a sensing signal/an integrated sensing and communication signal: The parameter defines a start moment (Start Time Instant) of a sensing signal/an integrated sensing and communication signal, and is also referred to as a time reference point.

Bandwidth of a sensing signal/an integrated sensing and communication signal: The parameter defines a total width of a frequency domain occupied by a sensing signal/an integrated sensing and communication signal.

Duration of a sensing signal/an integrated sensing and communication signal: The parameter defines total duration occupied by a sensing signal/an integrated sensing and communication signal.

First frequency offset (which may be represented as Frequency Offset 1): The parameter defines a frequency offset of a Costas array relative to a start frequency (namely, a frequency reference point) of a sensing signal/an integrated sensing and communication signal, and an acting object of the parameter is the Costas array. Optionally, the frequency offset may be represented by using a quantity of REs or RBs.

First time offset (which may be represented as Time Offset 1): The parameter defines a time offset of a Costas array relative to a start moment (namely, a time reference point) of a sensing signal/an integrated sensing and communication signal, and an acting object of the parameter is the Costas array. Optionally, the time offset may be represented by using an OFDM symbol or a quantity of slots (Slots).

Second frequency offset (Frequency Offset 2): The parameter defines a frequency offset of a Costas array set relative to a start frequency (namely, a frequency reference point) of a sensing signal/an integrated sensing and communication signal, and an acting object of the parameter is the Costas array set. Optionally, the frequency offset may be represented by using a quantity of REs or RBs.

Second time offset (Time Offset 2): The parameter defines a time offset of a Costas array set relative to a start moment (namely, a time reference point) of a sensing signal/an integrated sensing and communication signal, and an acting object of the parameter is the Costas array set. Optionally, the time offset may be represented by using an OFDM symbol or a quantity of slots (Slots).

Third frequency offset (Frequency Offset 3): The parameter defines a frequency offset of a Costas array relative to a reference frequency (for example, a lowest frequency) position of a Costas array set in which the Costas array is located, and an acting object of the parameter is the Costas array. Optionally, the frequency offset may be represented by using a quantity of REs or RBs. FIG. 3a is used as an example for description. Assuming that a frequency at which the first RE at the lower left corner shown in FIG. 3a is located is a lowest frequency in a Costas array set in which two Costas arrays in the figure are located, both first frequency offsets (indicated by P1 in the figure) of the two Costas arrays in FIG. 3a are two REs.

Third time offset (Time Offset 3): The parameter defines a time offset of a Costas array relative to a start moment of a Costas array set in which the Costas array is located, and an acting object of the parameter is the Costas array. Optionally, the time offset may be represented by using an OFDM symbol or a quantity of slots (Slots). FIG. 3a is used as an example for description. Assuming that a start moment of the first OFDM symbol at the lower left corner shown in FIG. 3a is a start moment of a Costas array set in which two Costas arrays in the figure are located, the first time offset (indicated by P2 in the figure) of the first Costas array from the left shown in FIG. 3a is one OFDM symbol, and the first time offset of the second Costas array from the left is eight OFDM symbols.

First frequency domain cycle (Frequency Cycle 1): If a Costas array set or a plurality of Costas arrays are evenly distributed at equal intervals in a frequency domain, the parameter defines a frequency domain interval between different Costas arrays.

First time domain cycle (Time Cycle 1): If a Costas array set or a plurality of Costas arrays are evenly distributed at equal intervals in a time domain, the parameter defines a time domain interval between different Costas arrays; FIG. 3a is used as an example for description. Assuming that two Costas arrays shown in the figure are two consecutive Costas arrays in a Costas array set, and a first time domain cycle (indicated by P3 in the figure) of the Costas array set is seven OFDM symbols.

Second frequency domain cycle (Frequency Cycle 2): If a plurality of Costas array sets are evenly distributed at equal intervals in a frequency domain, the parameter defines a frequency domain interval between different Costas array sets.

Second time domain cycle (Time Cycle 2): If a plurality of Costas array sets are evenly distributed at equal intervals in a time domain, the parameter defines a time domain interval between different Costas array sets.

Quantity of Costas arrays in a frequency domain: The parameter defines a quantity of Costas arrays in one Costas array set in a frequency domain, and an acting object of the parameter is the Costas array set.

Quantity of Costas arrays in a time domain: The parameter defines a quantity of Costas arrays in one Costas array set in a time domain, and an acting object of the parameter is the Costas array set.

Quantity of Costas array sets in a frequency domain: When a sensing signal/an integrated sensing and communication signal is configured to be constructed by more than one Costas array set, the parameter defines a quantity of Costas array sets of the signal in a frequency domain.

Quantity of Costas array sets in a time domain: When a sensing signal/an integrated sensing and communication signal is configured to be constructed by more than one Costa array set, the parameter defines a quantity of Costas array sets of the signal in a time domain.

Modulation sequence parameter of a Costas array: A Costas array or a Costas array set only indicates a time-frequency position of a sensing resource, and the time-frequency positions may further carry a symbol sequence agreed in advance. The modulation sequence parameter of a Costas array includes at least one of the following: i. an initial seed cᵢₙᵢₜ, to be specific, an input parameter of a pseudorandom sequence generator, adapted to generate a pseudorandom sequence of the first signal; and ii. a sequence index.

Muting pattern (Muting Pattern): A defined bitmap (bitmap) is used for indicating time positions (for example, symbols or slots) in a sensing resource set at which the first signal is to be muted and not transmitted.

Quasi co-location (Quasi co-location, QCL) information: Quasi co-location information between a time-frequency resource in which a Costas array is located and another reference signal is defined.

A configuration process of the first signal (referred to as a Costas sensing signal below) (or a configuration process of the first resource) is described below by using an example with reference to two specific embodiments: Embodiment 1 and Embodiment 2.

### Embodiment 1: Configure a Costas Sensing Signal (or a Sensing Resource) Based on a Formula Method

This embodiment describes necessary signaling transmission content and a procedure when the Costas sensing signal is configured based on the formula method.
S1: The signal sending node (namely, a sensing signal/an integrated sensing and communication signal sending device) sends the sensing signal configuration information (namely, the first configuration information) to the signal receiving node (namely, a sensing signal/an integrated sensing and communication signal receiving device); or a core network device (for example, a sensing function element (Sensing Function, SF), an access and mobility management function (Access and Mobility Management Function, AMF), or a sensing application server in a core network) sends the sensing signal configuration information to the signal sending node and the signal receiving node.

The sensing signal configuration information includes at least one of the following:
a type indication of a Costas array (any at least one of a Welch-Costas array, a Golomb-Costas array, and a Lempel-Costas array);
a prime number l used for generating a Costas array;
a primitive element (α or α and β) of a finite field used for generating a Costas array;
a non-zero element (η) of a finite field used for generating a Costas array; and
a power (m) of a prime number l used for generating a Costas array.

A configuration parameter used for determining a time-frequency position of a sensing signal corresponding to a Costas array includes at least one of the following: a start frequency of a sensing signal/an integrated sensing and communication signal, start time of a sensing signal/an integrated sensing and communication signal, a bandwidth of a sensing signal/an integrated sensing and communication signal, duration of a sensing signal/an integrated sensing and communication signal, a first frequency offset, a first time offset, a second frequency offset, a second time offset, a third frequency offset, a third time offset, a first frequency domain cycle, a first time domain cycle, a second frequency domain cycle, a second time domain cycle, a quantity of Costas arrays in a frequency domain, a quantity of Costas arrays in a time domain, a quantity of Costas array sets in a frequency domain, a quantity of Costas array sets in a time domain, a modulation sequence parameter of a Costas array, and a muting pattern.
S2: The signal sending node and/or the signal receiving node calculates the Costas array based on the sensing signal configuration information and any at least one of formula (1) to formula (5).
S3: The signal sending node and/or the signal receiving node configures the first resource based on the Costas array obtained through calculation.
S4: The signal sending node sends a sensing signal/an integrated sensing and communication signal by using the first resource.
S5: The signal sending node receives the sensing signal/integrated sensing and communication signal through the first resource.

### Embodiment 2: Configure a Costas Sensing Signal (or a Sensing Resource) Based on a Look-Up Table Method

This embodiment describes necessary signaling transmission content and a procedure when the Costas sensing signal is configured based on the look-up table method.
S1: The signal sending node (namely, a sensing signal/an integrated sensing and communication signal sending device) sends the sensing signal configuration information (namely, the first configuration information) to the signal receiving node (namely, a sensing signal/an integrated sensing and communication signal receiving device); or a core network device (for example, a sensing function element (Sensing Function, SF), an access and mobility management function (Access and Mobility Management Function, AMF), or a sensing application server in a core network) sends the sensing signal configuration information to the signal sending node and the signal receiving node.

The sensing signal configuration information includes at least one of the following:
a Costas signal order;
a Costas array index; and
a Costas array set index.

A configuration parameter used for determining a time-frequency position of a sensing signal corresponding to a Costas array includes at least one of the following: a start frequency of a sensing signal/an integrated sensing and communication signal, start time of a sensing signal/an integrated sensing and communication signal, a bandwidth of a sensing signal/an integrated sensing and communication signal, duration of a sensing signal/an integrated sensing and communication signal, a first frequency offset, a first time offset, a second frequency offset, a second time offset, a third frequency offset, a third time offset, a first frequency domain cycle, a first time domain cycle, a second frequency domain cycle, a second time domain cycle, a quantity of Costas arrays in a frequency domain, a quantity of Costas arrays in a time domain, a quantity of Costas array sets in a frequency domain, a quantity of Costas array sets in a time domain, a modulation sequence parameter of a Costas array, and a muting pattern.
S2: The signal sending node and/or the signal receiving node looks up a table based on the sensing signal configuration information to determine a Costas array/a Costas array set.
S3: The signal sending node and/or the signal receiving node configures the first resource based on the Costas array/Costas array set determined by looking up the table.
S4: The signal sending node sends a sensing signal/an integrated sensing and communication signal by using the first resource.
S5: The signal sending node receives the sensing signal/integrated sensing and communication signal through the first resource.

The foregoing are two specific embodiments of configuring the Costas sensing signal (or the sensing resource) based on the sensing signal configuration information of the Costas array.

In this embodiment of this application, an NR CSI reference signal (CSI Reference Signal, CSI-RS) configuration method used in a communication system may also be used to configure a sensing signal (or a sensing resource) based on a Costas array in this embodiment of this application. That is, in the sensing system/integrated sensing and communication system, the sensing signal (or the sensing resource) may be configured based on an NR CSI-RS architecture. It should be noted that configuration of a sensing signal (or a sensing resource) in this embodiment of this application is not limited to the NR CSI-RS architecture, and a more flexible signal pattern may further be configured based on related configuration information, for example, the sensing signal configuration information, to adapt to a future sensing system/integrated sensing and communication system.

The following first briefly describes how to configure a CSI-RS by using radio resource control (Radio Resource Control, RRC) signaling in an NR system.

In the NR system, in a process of configuring the CSI-RS, the network side device may first consider a preconfigured (pre-configured) system signal and a pre-reserved system channel, such as a synchronization signal block (Synchronization Signal Block, SSB), in the NR system. The SSB includes a primary synchronization signal (Primary Synchronization Signal, BSS), a secondary synchronization signal (Secondary Synchronization Signal, SSS), a physical broadcast channel (Physical broadcast channel, PBCH), and a dedicated demodulation reference signal (Dedicated demodulation reference signal, DM-RS). Therefore, a configured reference signal resource cannot coincide with a resource used by the system signals and system channels.

A CSI-RS signal may be configured by an information element (Information Element, IE) of the RRC, that is, CSI-MeasConfig. The CSI-MeasConfig may include information elements NZP-CSI-RS-Resource, NZP-CSI-RS-ResourceSet, and CSI-ResourceConfig.

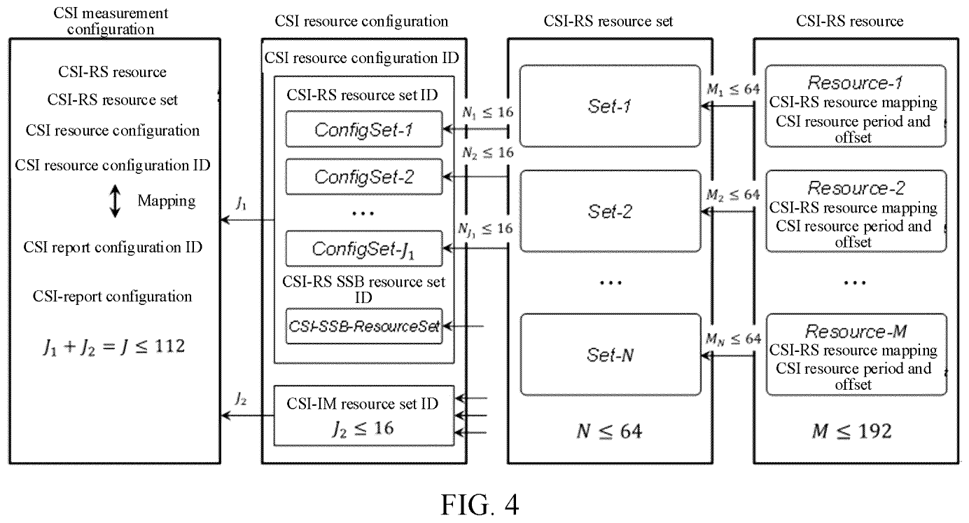

As shown in FIG. 4, the information element NZP-CSI-RS-Resource may be used for configuring a physical resource of the CSI-RS, namely, a mapping relationship (Resource Mapping) between a CSI-RS signal and an RE allocated in an OFDM time-frequency domain. A resource pool configured for a physical resource of the CSI-RS may have a maximum of 192 different types of physical resources, that is, M=192. Each CSI-RS physical resource has a corresponding ID.

Configured CSI-RS physical resources form a CSI-RS Resource Set (namely, a Resource Set) by using information elements CSI-RS-ResourceSet. A total quantity of resource sets may reach 64 at a maximum, that is, N=64. Each CSI-RS resource set has a corresponding ID. Each CSI-RS resource set is selected from a CSI-RS physical resource pool, and each resource set may have 64 physical resources of different types at most, that is, Mₙ=64. n is an index of a resource set, and 0≤n≤N.

The information element CSI-ResourceConfig may be used for configuring a CSI-RS resource configuration set, a quantity of CSI-RS resource configuration sets is J₁, and a total quantity of CSI-RS resource configuration sets and other resource configuration sets (namely, an SSB resource configuration set, an IM resource configuration J₂) may reach up to 112, that is, J₁+J₂=J≤112. The CSI-RS resource configuration set is selected from the CSI-RS resource set, and each CSI-RS resource configuration set may have a maximum of 16 CSI-RS resource sets of different types, that is, Nₗ=16, where 0≤l≤J₁. Each CSI-RS resource configuration set has a corresponding ID. In addition, the CSI-ResourceConfig specifies which CSI-ResourceConfig is to be used for measurement. A measurement type and a corresponding CSI-ResourceConfig ID are determined by using a mapping table.

Specifically, a CSI-RS time-frequency domain resource respectively configures a time-frequency domain resource in each slot (Slot) and a transmission time sequence of a channel state information (Channel State Information, CSI) in the slot by using RRC parameters CSI-RS-ResourceMapping and CSI-ResourcePeriodicityAndOffset in the information element NZP-CSI-RS-Resource.

More specifically, in each slot, a physical resource of a CSI-RS may be configured by using the information element CSI-RS-ResourceMapping. The information element CSI-RS-ResourceMapping mainly configures the following resource parameters:
frequencyDomainAllocation: It is an OFDM frequency domain resource position, and is implemented by using a bit mapping (Bit Mapping) method, and any one of 12 REs may be indicated based on a density of resources in the RB. An index of the first RE occupied herein is k₀.
firstOFDMSymbolInTimeDomain: It is a time domain position of the first OFDM symbol in each RB, and may indicate any one of 14 OFDM symbols. An index of the first OFDM symbol occupied herein is l₀.
cdm-Type: It is a type of code division multiplexing, that is, noCDM or CDM. A CDM-type resource is designed for a MIMO reference signal.
Density: It is a density of a CSI-RS in a frequency domain, may be 3, 1, or 0.5, and is represented by using a parameter ρ.

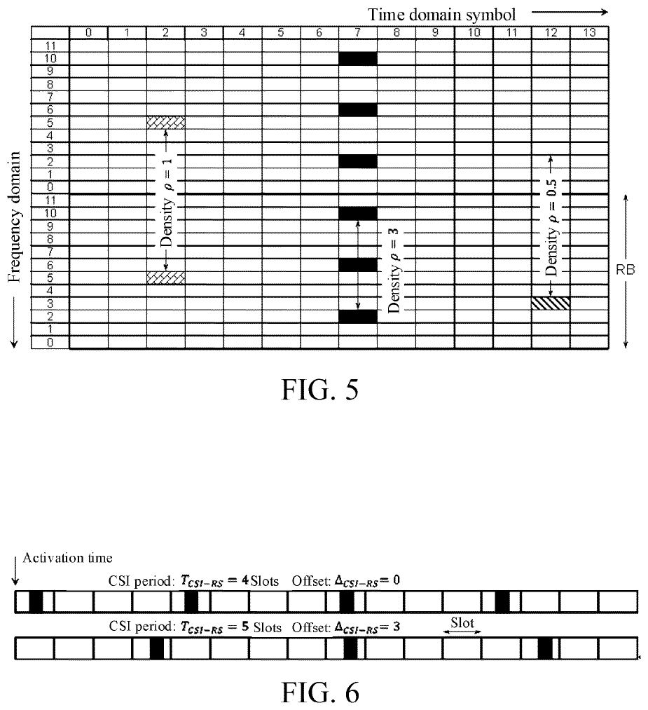

In the NR standard, parameters k₀, l₀, ρ, and cdm-Type are indicated in Table 7.4. 1.5. 3-1 of TS 38.211. Exemplary configuration parameters in the left shown in FIG. 5 are: an OFDM frequency domain resource position is 5, a time domain position of the first OFDM symbol is 2, a type of code division multiplexing is noCDM, and a density in a frequency domain is 1. Exemplary configuration parameters in the middle shown in FIG. 5 are: an OFDM frequency domain resource position is 2, a time domain position of the first OFDM symbol is 7, a type of code division multiplexing is noCDM, and a density in a frequency domain is 3. Exemplary configuration parameters in the right shown in FIG. 5 are: an OFDM frequency domain resource position is 3, a time domain position of the first OFDM symbol is 12, a type of code division multiplexing is noCDM, and a density in a frequency domain is 0.5.

A start position and a quantity of RBs of the CSI resource in the frequency domain are respectively provided by RRC parameters startingRBs and nrofRBs in an information element CSI-FrequencyOccupation. Specifically, startingRB defines a start physical resource block (Physical Resource Block, PRB) of a CSI resource relative to a common resource block #0 (CRB #0), which is numerically a number of PRB intervals from the CRB #0, and is allowed to be only a multiple of 4. nrofRBs defines a quantity of PRBs that a CSI resource spans. Only a multiple of 4 is allowed, and a minimum configurable number is a minimum of 24 and an associated bandwidth part (Bandwidth Part, BWP). If a configured value is greater than a width of the associated BWP, the UE needs to assume that an actual CSI-RS bandwidth is equal to the width of the associated BWP.

The sensing signal may be configured as a periodic sensing signal, or may be configured as an aperiodic sensing signal. When the sensing signal is configured as the periodic sensing signal, sensing signal parameters T_{CSI-RS} and Δ_{CSI-RS} can determine a sensing signal cycle feature.

More specifically, for a periodic CSI-RS, a CSI transmission time sequence in the slot is implemented by using a frame index and the RRC parameter CSI-ResourcePeriodicityAndOffset. Assuming that configured CSI-RS transmission occurs at each T_{CSI-RS}^{th} slot. T_{CSI-RS} is a resource period, and a range of the resource period may be T_{CSI-RS}=4, 5, 8, 10, 16, 20, . . . , 320, 640, and a CSI-RS position offset is represented by Δ_{CSI-RS}.

FIG. 6 shows two configurations of CSI-RS resource periods T_{CSI-RS} of 4 and 5, respectively, where the CSI-RS offsets Δ_{CSI-RS} are 0 and 3, respectively.

It should be noted that a periodic CSI-RS offset is calculated based on activation timing (Activation Timing).

When the sensing signal is configured as the aperiodic sensing signal, based on a parameter aperiodicTriggeringOffset in the information element NZP-CSI-RS-ResourceSet, an offset between corresponding downlink control information (Downlink Control Information, DCI) and sending the CSI-RS is determined. In other words, aperiodicTriggeringOffset is the offset between a slot of the DCI that triggers the aperiodic CSI-RS resource set and a slot of sending the CSI-RS resource set.

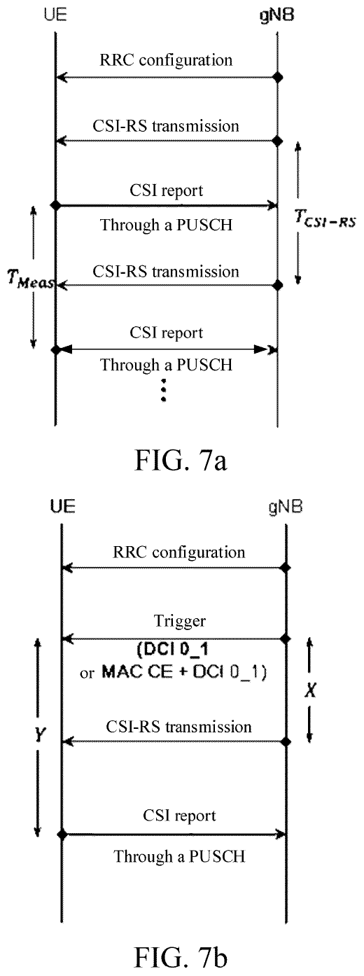

As shown in FIG. 7a, when the sensing signal is configured as the periodic sensing signal, the network side device sends the CSI-RS based on a configured periodic slot. Similarly, the terminal receives the CSI-RS based on the configured periodic slot, and calculates a required measurement quantity related to the CSI-RS. The terminal feeds back the measurement quantity related to the CSI-RS through a physical uplink shared channel (Physical Uplink Shared Channel, PUSCH). In the IE of CSI-MeasConfig, the period T_{CSI-RS} of the CSI-RS is configured by CSI-ResourcePeriodicityAndOffset, and a measurement period T_{Meas} of the CSI is determined by using a resource period configured based on the PUSCH. Certainly, through RRC configuration, T_{CSI-RS}=T_{Meas}.

As shown in FIG. 7b, when the sensing signal is configured as the aperiodic perceptual signal, the network side device triggers sending and measurement of the CSI-RS through a method of sending DCI 0_1 or MAC CE+DCI 0_1. The triggered CSI-RS is calculated starting from the slot of the DCI and is sent after the offset aperiodicTriggeringOffset. The triggered measurement is calculated starting from the slot of the DCI and fed back after the offset CSIreportSlotOffsetList. It should be noted that the CSIreportSlotOffsetList and a PUSCH configuration offset are the same.

In this embodiment of this application, based on a current CSI-RS configuration method of the NR protocol, a sensing signal (or a sensing resource) may be configured based on a Costas array.

In some embodiments, that the signal sending node determines the first array includes:
the signal sending node receives second configuration information, where the second configuration information is used for configuring a channel state information reference signal CSI-RS; and
the signal sending node determines the first array based on the second configuration information.

The second configuration information may be referred to as CSI-RS configuration information. In this implementation, the signal sending node may configure the first array based on the CSI-RS configuration information.

In some embodiments, that a signal sending node configures a first resource based on a predetermined first array includes:
the signal sending node determines a configuration parameter of a CSI-RS based on the predetermined first array; and
the signal sending node configures the first resource based on the configuration parameter of the CSI-RS.

In this implementation, the signal sending node may determine the CSI-RS configuration information based on the predetermined first array and configure the first resource based on the configuration parameter of the CSI-RS.

The following describes an implementation of configuring a Costas array based on an NR CSI-RS with reference to a specific embodiment: Embodiment 3.

### Embodiment 3: Configure a Costas Array by Using an NR CSI-RS

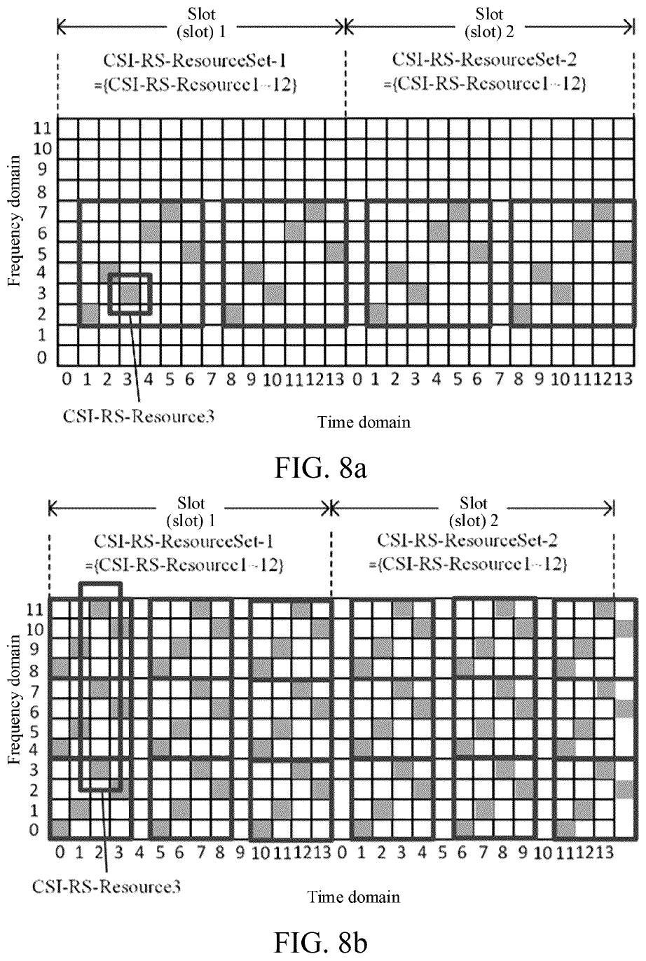

An example in which a minimum time-frequency unit to which a Costas array is mapped is an RE is used for description, and a configuration of a Costas array is used as an example for description. A specific method is as follows:
Step 1: Based on requirements of sensing/integrated sensing and communication, determine a Costas array/Costas array set used for constructing the sensing signal/integrated sensing and communication signal, and determine a time-frequency resource position of at least one Costas array.
Step 2: Configure a time-frequency domain resource in each slot (Slot) through the RRC parameters CSI-RS-ResourceMapping and CSI-ResourcePeriodicityAndOffset in the information element NZP-CSI-RS-Resource. Specifically, using FIG. 8a as an example, within the RB and a slot 1 (Slot1), for example, for a Costas signal of the fourth RE and the fourth OFDM symbol (which is a resource grid circled in a small box in the figure), the parameter frequencyDomainAllocation of the corresponding information element CSI-RS-ResourceMapping is set to row2, and a corresponding bitmap is ‘000000001000’ (that is, k₀ is 3 in Table 7.4.1.5.3-1 of 3GPP TS 38.211), and the parameter firstOFDMSymbolInTimeDomain of the corresponding information element CSI-RS-ResourceMapping (that is, l₀ in Table 7.4.1.5.3-1 of 3GPP TS 38.211) is configured as 3. For the example in FIG. 8a, a frequency domain density parameter ρ (density) in Table 7.4. 1.5. 3-1 of 3GPP TS 38.211 may be configured as 1 or 0.5. When ρ=1, a signal pattern shown in FIG. 8a is repeated in each RB. When ρ=0.5, a signal pattern shown in FIG. 8a occurs once at intervals of one RB. Herein, cdm-Type is noCDM.
Step 3: Repeat the operation in Step 2, and configure all time-frequency positions on the Costas array in the RB and the slot. Each configured Costas array resource grid is one NZP-CSI-RS-Resource. For example, the Costas signal of the fourth RE and the fourth OFDM symbol (which is the resource grid circled in the small box in the figure) in the slot 1 (Slot1) may be numbered as CSI-RS-Resource3. Two Costas arrays in FIG. 8a form one NZP-CSI-RS-ResourceSet, including a total of 12 pieces of NZP-CSI-RS-Resource (that is, CSI-RS-Resource 1 to 12 in FIG. 8a). Optionally, alternatively, the first Costas array may form one NZP-CSI-RS-ResourceSet (including six pieces of NZP-CSI-RS-Resource in total), and the second Costas array may form another NZP-CSI-RS-ResourceSet.

Step 2 and step 3 are described by using FIG. 8b as an example. In FIG. 8b, a total of nine Costas arrays of order 4 are included in one RB and one slot, and three REs are occupied by one NZP-CSI-RS-Resource in one OFDM symbol, that is, a frequency domain density parameter ρ is configured as 3. In this case, a signal pattern shown in FIG. 8b is repeated in each RB. For each NZP-CSI-RS-Resource, the parameter frequencyDomainAllocation is configured separately (in other words, k₀ is separately controlled in Table 7.4.1.5.3-1 of 3GPP TS 38.211). For example, for a Costas signal of the third OFDM symbol of a slot 1 (Slot1) (which is a resource grid circled in a small box in the figure) in FIG. 8b, the configuration parameter frequencyDomainAllocation is set to row1, and a corresponding bitmap is ‘1000’ (that is, k₀ in Table 7.4.1.5.3-1 of 3GPP TS 38.211 is set to 3). In the slot 1 (Slot1), there are a total of 12 pieces of NZP-CSI-RS-Resource (namely, CSI-RS-Resource 1 to 12 in FIG. 8b), forming one NZP-CSI-RS-ResourceSet (namely, CSI-RS-ResourceSet-1 in FIG. 8b).

Further, a start position of the CSI resource configured in step 2 and step 3 in the frequency domain and a quantity of RBs occupied by the CSI resource may be configured based on the RRC parameters startingRB and nrofRBs in the information element CSI-FrequencyOccupation. For example, if in FIG. 8a, it is configured that startingRB=24 and nrofRBs=72, and in FIG. 8b, it is configured that startingRB=24 and nrofRBs=24, in this case, for a same quantity of slots, quantities of CSI resources used for sensing are the same for the two configurations.

It should be noted that for the nine Costas arrays of order 4, for example, one Costas array of order 36 may alternatively be used. Both of the nine Costas arrays of order 4 and the Costas array of order 36 can uniformly distribute the sidelobe of the ambiguity function on a delay-doppler domain (distributed shapes may be different). If basic units are all REs, distribution of sensing signals of order 36 is sparser, distribution of nine Costas arrays of order 4 is denser, and a signal resolution of the former may be higher, which is reflected in a sharper mainlobe on the ambiguity function. In a case of a same quantity of available time-frequency resources, a specific type of the Costas array for use and a distribution manner of the Costas array need to be determined based on at least one of the following factors:
a delay and/or a doppler resolution requirement;
a maximum unambiguous delay and/or doppler range requirement;
a range of a time-frequency resource that may be used for sensing/integrated sensing and communication (that is, a span size of a time domain and/or a frequency domain in which the Costas array may be placed);
configuration signaling overhead;
configuration complexity;
a sensing signal-to-noise ratio (Signal-to-Noise Ratio, SNR) requirement;
a signal transmitting power requirement;
a signal PAPR requirement; and
communication quality of service (Quality of Service, QoS).

In the example in FIG. 8b, one RB and one slot (Slot) include at most nine Costas arrays of order 4. If the same quantity (which is 36) of time-frequency resource units are used, one Costas array of order 36, two Costas arrays of order 18, three Costas arrays of order 12, four Costas arrays of order 9, or six Costas arrays of order 6 may be generated. If a resolution requirement for a dimension (for example, a delay/doppler) is higher than a resolution requirement for another dimension, a solution in which a plurality of Costas arrays of order n (n=6, 9, 12, 18) are arranged in series on the dimension may be adopted. When both the delay and doppler dimensions require high resolution, one Costas array of order 36, or four Costas arrays of order 9 arranged in 2 rows and 2 columns, or nine Costas arrays of order 4 arranged in 3 rows and 3 columns as shown in FIG. 8b may be used. When the range of the time-frequency resource that may be used for the sensing/integrated sensing and communication is small, a dense arrangement of nine Costas arrays of order 4 arranged in 3 rows and 3 columns may be used.

Step 4: A period and a related resource offset of the Costas array are implemented by configuring the parameter CSI-ResourcePeriodicityAndOffset. Specifically, as shown in FIG. 8a, for NZP-CSI-RS-Resource in NZP-CSI-RS-ResourceSet (namely, CSI-RS-ResourceSet-1 in the figure) in the slot 1 (Slot1), the parameter CSI-ResourcePeriodicityAndOffset (namely, Δ_{CSI-RS}) may be configured as 0; and for NZP-CSI-RS-Resource in NZP-CSI-RS-ResourceSet (namely, CSI-RS-ResourceSet-2 in the figure) in a slot 2 (Slot2), the parameter CSI-ResourcePeriodicityAndOffset (namely, Δ_{CSI-RS}) may be configured as 1. In addition, four NZP-CSI-RS-ResourceSet may be configured, and a period T_{CSI-RS} of each NZP-CSI-RS-ResourceSet is set to 4, to implement a dense periodic signal shown in FIG. 8a. For FIG. 8b, similar operations are applied.

It should be noted that the sensing signal based on the Costas array in this embodiment of this application may be used for parameter estimation of a sensing target/sensing area, and may also be used for synchronization and channel estimation of communication.

Although the Costas arrays is a finite set, quantities of Costas arrays of different orders are different greatly. Based on a current NR frame structure, this embodiment of this application provides several Costas array sets suitable for sensing/integrated sensing and communication in the NR frame structure.

It should be noted that all Costas arrays of different orders have a “pin-shaped” ambiguity function, and are theoretically suitable for being used as the sensing signal. However, considering a current NR structure, using some Costas arrays may make configuration more convenient and flexible, and reduce configuration overhead.

It should be further noted that the idea of this application is to construct the sensing signal/the integrated sensing and communication signal by using the Costas array, and is not limited to an NR architecture. That is, it falls within the protection scope of this application to construct a sensing signal/an integrated sensing and communication signal based on any Costas array.

Costas arrays that may be used as a sensing signal/an integrated sensing and communication signal are provided below in a table form, where each row represents one Costas array, and a number in the table represents a frequency (relative) index of Costas. It should be noted that for some of the following arrays, after rotation/flipping, an array of all Costas arrays of this order can be obtained. In this embodiment of this application, the array is referred to as a “basic Costas array”. For some orders, a quantity of basic Costas arrays is relatively large. This embodiment of this application only provides some examples thereof, and complete data may be obtained from reference [7].

TABLE 2
Costas arrays of order 3 that may be used as a sensing
signal/an integrated sensing and communication signal

| | | |
|---|---|---|
| 0 | 2 | 1 |
| 1 | 0 | 2 |
| 1 | 2 | 0 |
| 2 | 0 | 1 |

Note:
Table 2 lists all four Costas arrays of order 3. In a frequency domain, one RB can be filled, and a total number is four. This is applicable to a situation of limited sensing resources.

TABLE 3
Basic Costas arrays of order 4 that may be used as a sensing
signal/an integrated sensing and communication signal

| | | | |
|---|---|---|---|
| 0 | 1 | 3 | 2 |
| 0 | 2 | 3 | 1 |

Note:
Table 3 lists two Costas arrays of order 4. In a frequency domain, one RB can be filled. In a time domain, an interval is one OFDM symbol, three arrays can be placed in one slot, and 4 + 1 = 5, which is a prime number. This can construct a Costas array with a proper period. There are 12 available Costas arrays of this order in total, and can be obtained by rotating/flipping the basic Costas array listed in this table.

TABLE 4
Basic Costas arrays of order 6 that may be used as a sensing
signal/an integrated sensing and communication signal

| | | | | | |
|---|---|---|---|---|---|
| 0 | 1 | 4 | 3 | 5 | 2 |
| 0 | 2 | 1 | 4 | 5 | 3 |
| 0 | 2 | 5 | 3 | 4 | 1 |
| 0 | 3 | 2 | 4 | 5 | 1 |
| 0 | 3 | 4 | 2 | 1 | 5 |
| 0 | 3 | 5 | 4 | 1 | 2 |
| 0 | 4 | 2 | 3 | 5 | 1 |
| 0 | 4 | 2 | 5 | 1 | 3 |
| 0 | 4 | 3 | 5 | 1 | 2 |
| 0 | 5 | 2 | 4 | 3 | 1 |
| 0 | 5 | 3 | 2 | 4 | 1 |
| 1 | 2 | 5 | 0 | 4 | 3 |
| 1 | 3 | 0 | 5 | 4 | 2 |
| 1 | 3 | 2 | 5 | 0 | 4 |
| 1 | 3 | 4 | 0 | 5 | 2 |
| 1 | 4 | 0 | 5 | 2 | 3 |
| 1 | 4 | 0 | 5 | 3 | 2 |

Note:
Table 4 lists four Costas arrays of order 6. In a frequency domain, one RB can be filled. In a time domain, an interval is one OFDM symbol, two arrays can be placed in one slot, and 6 + 1 = 7, which is a prime number. This can construct a Costas array with a proper period. There are 116 available Costas arrays of this order in total, and can be obtained by rotating/flipping the basic Costas array listed in this table.

TABLE 5
Basic Costas arrays of order 12 that may be
used as a sensing signal/an integrated
sensing and communication signal

| | | | | | | | | | | | |
|---|---|---|---|---|---|---|---|---|---|---|---|
| 0 | 1 | 3 | 7 | 2 | 5 | 11 | 10 | 8 | 4 | 9 | 6 |
| 0 | 1 | 3 | 11 | 9 | 6 | 5 | 10 | 4 | 7 | 2 | 8 |
| 0 | 1 | 5 | 11 | 6 | 9 | 3 | 8 | 7 | 4 | 2 | 10 |
| 0 | 1 | 7 | 11 | 6 | 8 | 4 | 2 | 5 | 10 | 9 | 3 |
| 0 | 1 | 10 | 4 | 3 | 8 | 11 | 9 | 5 | 7 | 2 | 6 |
| 0 | 3 | 9 | 7 | 11 | 4 | 6 | 5 | 2 | 10 | 1 | 8 |
| 0 | 3 | 9 | 10 | 5 | 2 | 4 | 8 | 6 | 11 | 7 | 1 |
| 0 | 3 | 10 | 1 | 9 | 6 | 5 | 7 | 11 | 4 | 2 | 8 |
| 0 | 3 | 11 | 5 | 7 | 8 | 4 | 2 | 9 | 6 | 10 | 1 |
| 0 | 5 | 8 | 10 | 9 | 1 | 7 | 3 | 4 | 2 | 11 | 6 |
| 0 | 6 | 7 | 10 | 8 | 3 | 11 | 5 | 9 | 2 | 4 | 1 |
| 0 | 6 | 9 | 4 | 8 | 10 | 11 | 5 | 2 | 7 | 3 | 1 |
| 0 | 7 | 4 | 2 | 3 | 11 | 5 | 9 | 8 | 10 | 1 | 6 |
| 0 | 7 | 8 | 3 | 5 | 2 | 10 | 6 | 11 | 9 | 1 | 4 |
| 0 | 7 | 10 | 4 | 9 | 8 | 5 | 3 | 11 | 1 | 2 | 6 |
| 1 | 0 | 6 | 9 | 4 | 8 | 10 | 11 | 5 | 2 | 7 | 3 |
| 1 | 2 | 5 | 3 | 10 | 6 | 0 | 4 | 9 | 11 | 8 | 7 |
| 1 | 2 | 11 | 3 | 9 | 7 | 6 | 10 | 0 | 5 | 8 | 4 |
| 1 | 4 | 11 | 2 | 10 | 7 | 6 | 8 | 0 | 5 | 3 | 9 |
| 1 | 5 | 11 | 9 | 8 | 0 | 2 | 7 | 10 | 6 | 3 | 4 |
| 1 | 6 | 9 | 11 | 10 | 2 | 8 | 4 | 5 | 3 | 0 | 7 |
| 1 | 7 | 6 | 11 | 2 | 0 | 8 | 10 | 5 | 9 | 3 | 4 |
| 1 | 8 | 5 | 3 | 4 | 0 | 6 | 10 | 9 | 11 | 2 | 7 |
| 1 | 8 | 9 | 4 | 6 | 3 | 11 | 7 | 0 | 10 | 2 | 5 |
| 1 | 8 | 11 | 3 | 9 | 7 | 0 | 4 | 6 | 5 | 2 | 10 |
| 1 | 8 | 11 | 5 | 10 | 9 | 6 | 4 | 0 | 2 | 3 | 7 |
| 2 | 1 | 10 | 0 | 5 | 9 | 3 | 11 | 6 | 4 | 7 | 8 |
| 2 | 3 | 6 | 4 | 11 | 7 | 1 | 5 | 10 | 0 | 9 | 8 |
| 2 | 5 | 0 | 11 | 9 | 1 | 6 | 8 | 7 | 4 | 10 | 3 |
| 2 | 6 | 11 | 1 | 8 | 7 | 9 | 5 | 0 | 10 | 3 | 4 |
| 2 | 7 | 10 | 0 | 11 | 3 | 9 | 5 | 6 | 4 | 1 | 8 |
| 2 | 8 | 7 | 0 | 3 | 1 | 9 | 11 | 6 | 10 | 4 | 5 |
| 3 | 4 | 1 | 5 | 11 | 9 | 8 | 0 | 2 | 7 | 10 | 6 |
| 3 | 9 | 5 | 10 | 8 | 0 | 2 | 11 | 6 | 7 | 1 | 4 |

Note:
Table 5 lists 34 Costas arrays of order 12. In a frequency domain, one RB can be filled. In a time domain, 13 OFDM symbols are occupied, and 12 + 1 = 13, which is a prime number. This can construct a Costas array with a proper period. There are 7852 available Costas arrays of this order in total, and the Costas arrays listed in this table are a part of basic Costas arrays thereof.

TABLE 6
Basic Costas arrays of order 24 that may be used as a sensing signal/an integrated
sensing and communication signal

| | | | | | | | | | | | | | | | | | | | | | | | |
|---|---|---|---|---|---|---|---|---|---|---|---|---|---|---|---|---|---|---|---|---|---|---|---|
| 0 | 2 | 17 | 18 | 23 | 10 | 3 | 12 | 1 | 15 | 22 | 5 | 21 | 6 | 14 | 11 | 9 | 19 | 13 | 8 | 7 | 20 | 16 | 4 |
| 0 | 3 | 20 | 7 | 5 | 12 | 18 | 4 | 15 | 14 | 22 | 23 | 11 | 1 | 13 | 17 | 6 | 8 | 21 | 16 | 9 | 19 | 10 | 2 |
| 0 | 4 | 23 | 15 | 11 | 5 | 7 | 2 | 1 | 10 | 3 | 17 | 20 | 8 | 19 | 9 | 6 | 14 | 21 | 12 | 13 | 18 | 16 | 22 |
| 0 | 11 | 15 | 21 | 17 | 7 | 8 | 6 | 20 | 12 | 9 | 19 | 14 | 2 | 4 | 23 | 22 | 1 | 18 | 5 | 13 | 16 | 10 | 3 |
| 1 | 15 | 19 | 12 | 7 | 10 | 20 | 0 | 11 | 17 | 3 | 21 | 23 | 22 | 5 | 6 | 4 | 9 | 18 | 2 | 14 | 8 | 16 | 13 |
| 2 | 13 | 8 | 23 | 11 | 15 | 5 | 14 | 0 | 7 | 1 | 19 | 12 | 10 | 9 | 6 | 16 | 21 | 3 | 4 | 17 | 20 | 22 | 18 |
| 3 | 2 | 15 | 12 | 21 | 14 | 10 | 4 | 6 | 23 | 9 | 20 | 7 | 19 | 22 | 13 | 5 | 0 | 16 | 1 | 11 | 17 | 18 | 8 |
| 3 | 14 | 10 | 20 | 13 | 11 | 6 | 23 | 22 | 19 | 1 | 16 | 2 | 21 | 0 | 8 | 17 | 7 | 12 | 15 | 4 | 5 | 18 | 9 |
| 3 | 21 | 8 | 10 | 16 | 7 | 2 | 18 | 11 | 19 | 4 | 17 | 0 | 1 | 13 | 20 | 23 | 22 | 14 | 12 | 6 | 15 | 5 | 9 |
| 4 | 3 | 9 | 19 | 21 | 17 | 15 | 0 | 11 | 14 | 22 | 1 | 23 | 10 | 2 | 20 | 8 | 5 | 12 | 13 | 7 | 16 | 6 | 18 |
| 4\| | 7 | 9 | 20 | 19 | 14 | 8 | 22 | 12 | 17 | 5 | 1 | 21 | 2 | 11 | 23 | 10 | 3 | 16 | 0 | 18 | 15 | 6 | 13 |
| 4 | 9 | 15 | 2 | 13 | 22 | 21 | 5 | 8 | 1 | 23 | 3 | 18 | 12 | 0 | 17 | 14 | 16 | 20 | 10 | 6 | 7 | 19 | 11 |
| 4 | 13 | 7 | 8 | 21 | 17 | 5 | 15 | 22 | 1 | 18 | 23 | 0 | 20 | 12 | 11 | 2 | 10 | 3 | 14 | 16 | 19 | 9 | 6 |
| 4 | 14 | 15 | 6 | 10 | 9 | 1 | 13 | 22 | 19 | 21 | 2 | 23 | 7 | 0 | 20 | 16 | 5 | 3 | 17 | 12 | 18 | 8 | 11 |
| 4 | 19 | 14 | 16 | 8 | 21 | 7 | 23 | 2 | 11 | 15 | 3 | 13 | 10 | 0 | 22 | 9 | 5 | 12 | 20 | 1 | 6 | 18 | 17 |
| 5 | 2 | 11 | 14 | 16 | 12 | 13 | 23 | 9 | 7 | 18 | 1 | 17 | 8 | 3 | 22 | 21 | 15 | 0 | 4 | 19 | 6 | 20 | 10 |
| 5 | 14 | 3 | 21 | 13 | 15 | 0 | 19 | 1 | 9 | 20 | 4 | 16 | 12 | 2 | 18 | 22 | 23 | 6 | 11 | 17 | 10 | 8 | 7 |
| 5 | 14 | 8 | 18 | 20 | 3 | 4 | 16 | 15 | 12 | 17 | 7 | 23 | 0 | 21 | 10 | 2 | 19 | 1 | 9 | 22 | 6 | 13 | 11 |
| 5 | 19 | 3 | 15 | 11 | 21 | 13 | 2 | 22 | 20 | 6 | 10 | 7 | 1 | 0 | 23 | 16 | 17 | 4 | 12 | 14 | 9 | 18 | 8 |
| 6 | 9 | 16 | 14 | 7 | 11 | 0 | 17 | 2 | 21 | 20 | 15 | 23 | 13 | 5 | 1 | 22 | 10 | 12 | 18 | 4 | 19 | 3 | 8 |
| 6 | 21 | 14 | 9 | 13 | 18 | 19 | 7 | 3 | 5 | 4 | 23 | 20 | 0 | 12 | 15 | 2 | 11 | 22 | 8 | 16 | 10 | 1 | 17 |
| 6 | 21 | 15 | 16 | 12 | 2 | 13 | 4 | 20 | 17 | 5 | 0 | 10 | 8 | 14 | 23 | 7 | 19 | 18 | 22 | 9 | 1 | 3 | 11 |
| 7 | 12 | 18 | 13 | 20 | 10 | 9 | 17 | 1 | 3 | 19 | 23 | 6 | 2 | 5 | 15 | 0 | 21 | 14 | 11 | 22 | 4 | 16 | 8 |
| 7 | 14 | 2 | 11 | 5 | 21 | 18 | 20 | 19 | 10 | 0 | 4 | 23 | 6 | 12 | 22 | 3 | 1 | 15 | 8 | 13 | 16 | 17 | 9 |
| 8 | 17 | 1 | 5 | 13 | 19 | 20 | 6 | 23 | 0 | 18 | 15 | 10 | 21 | 14 | 4 | 16 | 3 | 2 | 22 | 11 | 7 | 9 | 12 |

Note:
Table 6 lists 25 Costas arrays of order 24. In a frequency domain, two RBs can be filled. There are 200 available Costas arrays of this order in total, and can be obtained by rotating/flipping the basic Costas array listed in this table.

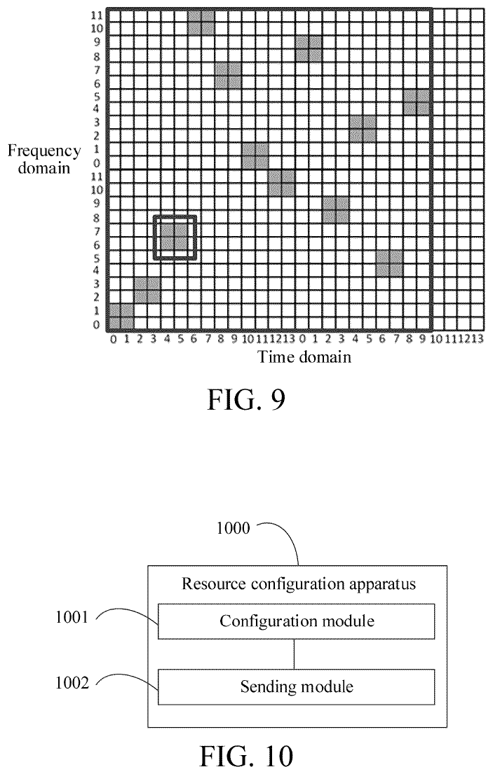

To further explain this solution, FIG. 9 is a schematic diagram of a mapping relationship of a resource of a Costas array across RBs and slots in OFDM based on Table 6 (Costas arrays corresponding to the second row). In this example, the Costas array of order 12 crosses two RBs in the frequency domain, and crosses two slots in the time domain. In this case, sensing resource configuration may be separately performed for each RB and each slot, and after the configuration is completed, the RB and the slot are spliced together to form a final signal pattern. In addition, in this example, a basic unit to which the Costas array element is mapped is four consecutive (time-frequency domain) REs (for example, a resource grid circled in a small box in FIG. 9). Optionally, the Costas array may be multiplexed by using a CDM manner similar to the CSI-RS for each mapping unit, to implement cooperative sensing of a multi-sense signal transmitting node or sensing of a multi-antenna port. Optionally, during actual configuration, only at least one of the four consecutive REs may be mapped.

In some embodiments, the method further includes:
in a case in which an available resource of the signal sending node is greater than the first resource, the signal sending node transmits a second signal by using a resource other than the first resource in the available resource, where the second signal is a signal related to a communication service.

That the available resource of the signal sending node is greater than the first resource may be understood as that, in addition to the time-frequency resource to which the Costas array is mapped, there is another time-frequency resource within the available time-frequency resource range of the signal sending node. At least a part of the another time-frequency resource may be used for transmission of data and/or a control signal, that is, for transmission of a signal related to the communication service. Certainly, none of the another time-frequency resource may perform any signal transmission.

In this implementation, resource utilization can be improved by using another resource other than the first resource in the available resources to transmit the second signal.

In some embodiments, after a signal sending node configures a first resource based on a predetermined first array, the method further includes:
the signal sending node performs a first operation in a case in which the first resource conflicts with a transmission resource of a third signal, where
the third signal is a signal related to the communication service, and the first operation includes any one of the following:
the signal sending node sends the first signal at a conflicting resource position of the first array by using a regenerated second array, where the second array includes at least one Costas array or at least one Costas array set;
the signal sending node sends the first signal at the conflicting resource position of the first array by using a neighboring non-conflicting resource position;
the signal sending node sends the first signal at the conflicting resource position of the first array by using a third array, where a resource to which the third array is mapped does not conflict with the transmission resource of the third signal, and the third array includes at least one of a quadratic congruence (Quadratic Congruence) array, a cubic congruence (Cubic Congruence) array, and a discrete linear frequency modulation (Linear Frequency Modulation, LFM) array; and
the signal sending node cancels sending of the first signal at the conflicting resource position of the first array.

In this implementation, after the used Costas array and the time-frequency resource position at which the Costas array is located are determined, if the time-frequency resource occupied by the Costas array conflicts with (or overlaps with) a time-frequency resource of a current data signal, reference signal, or synchronization signal, one of the following operations may be performed to avoid a resource conflict: i. regenerating or reselecting a Costas array used for constructing a sensing signal/an integrated sensing and communication signal; ii. performing local adjustment on a current Costas array, for example, migrating a Costas signal at a conflicting time-frequency resource to a neighboring time-frequency position that does not conflict, or canceling sending of the Costas signal at the conflicting resource position; or iii. replacing a current Costas array with another array having suboptimal sensing performance at a conflicting time-frequency resource position, where an array used for replacement may be a quadratic congruence array, a cubic congruence array, a discrete linear frequency modulation array, or the like.

In this implementation, the time-frequency resource conflict between the Costas array and another signal is resolved by using the foregoing operations, so that sensing performance and communication performance can be both considered.

In some embodiments, after that the signal sending node determines the first array, the method further includes:
the signal sending node modulates the first array by using a preset mapping symbol sequence, where the mapping symbol sequence includes at least one of an all 1s sequence, a Zadoff-Chu sequence (namely, a ZC sequence), an m sequence, and a Gold sequence.

In conclusion, a resource sequence of a first resource configured based on the Costas array has a “pin-shaped” ambiguity function. The first signal is sent by using the first resource, so that a main peak of the first signal is high and sharp, a sub-peak is low and flat, and a signal resolution is high. It can be learned that signal sensing performance can be improved according to this embodiment of this application.

For the resource configuration method provided in the embodiments of this application, an execution body may be a resource configuration apparatus. In the embodiments of this application, an example in which the resource configuration apparatus executes the resource configuration method is used to describe the resource configuration apparatus provided in the embodiments of this application.

Referring to FIG. 10, an embodiment of this application further provides a resource configuration apparatus, which may be used for a signal sending node. As shown in FIG. 10, a resource configuration apparatus 1000 includes:
a configuration module 1001, adapted to configure a first resource based on a predetermined first array, where the first array includes at least one Costas array or at least one Costas array set, and each Costas array set includes at least one Costas array; and a sending module 1002, adapted to send a first signal by using the first resource.
Optionally, the first signal is a signal related to a sensing service or an integrated sensing and communication service.

Optionally, the resource configuration apparatus 1000 further includes:
a transmission module, adapted to transmit, in a case in which an available resource of the signal sending node is greater than the first resource, a second signal by using a resource other than the first resource in the available resource, where the second signal is a signal related to a communication service.

Optionally, the resource configuration apparatus 1000 further includes:
a determining module, adapted to determine the first array.

Optionally, the determining module is specifically adapted to:
determine a structure of the first array and a position of a time-frequency resource to which the first array is mapped.

Optionally, the determining module is specifically adapted to performing any one of the following:
determining the structure of the first array based on an algebraic construction method; or
determining the structure of the first array based on a look-up table method.

Optionally, the determining module is specifically adapted to:
determine the structure of the first array based on at least one of the following: order indication information of a Costas array, type indication information of a Costas array, a prime number of a Costas array, a primitive element of a finite field of a Costas array, a non-zero element of a finite field of a Costas array, a power of a prime number of a Costas array, resource mapping granularity indication information of a Costas array, a Costas array set index, and a Costas array index.

Optionally, the determining module is specifically adapted to:
determine, based on a start frequency of the first signal, start time of the first signal, a frequency offset of the first array, and a time offset of the first array, the position of the time-frequency resource to which the first array is mapped.

Optionally, in a case in which the first array includes at least two Costas arrays or includes at least two Costas array sets, the first array includes at least one of the following:
at least two Costas arrays arranged at an interval in a frequency domain;
at least two Costas arrays arranged at an interval in a time domain;
at least two Costas array sets arranged at an interval in the frequency domain; and
at least two Costas array sets arranged at an interval in the time domain.

Optionally, the at least two Costas arrays have a same order and structure; or
the at least two Costas arrays have a same order and different structures; or the at least two Costas arrays have different orders and structures.

Optionally, the resource configuration apparatus 1000 further includes:
a performing module, adapted to perform a first operation in a case in which the first resource conflicts with a transmission resource of a third signal, where
the third signal is a signal related to the communication service, and the performing module is specifically adapted to perform any one of the following:
sending the first signal at a conflicting resource position of the first array by using a regenerated second array, where the second array includes at least one Costas array or at least one Costas array set;
sending the first signal at the conflicting resource position of the first array by using a neighboring non-conflicting resource position;
sending the first signal at the conflicting resource position of the first array by using a third array, where a resource to which the third array is mapped does not conflict with the transmission resource of the third signal, and the third array includes at least one of a quadratic congruence array, a cubic congruence array, and a discrete linear frequency modulation array; and
canceling sending of the first signal at the conflicting resource position of the first array.

Optionally, the resource configuration apparatus 1000 further includes:
a modulation module, adapted to modulate the first array by using a preset mapping symbol sequence, where the mapping symbol sequence includes at least one of an all 1s sequence, a Zadoff-Chu sequence, an m sequence, and a Gold sequence.

Optionally, the Costas array includes at least one of a Welch-Costas array, a Golomb-Costas array, and a Lempel-Costas array.

Optionally, the resource configuration apparatus 1000 further includes:
a first receiving module, adapted to receive first configuration information, where the first configuration information is used for configuring the first signal; and
the determining module is specifically adapted to:
determine the first array based on the first configuration information.

Optionally, the resource configuration apparatus 1000 further includes:
a second receiving module, adapted to receive second configuration information,
where the second configuration information is used for configuring a channel state information reference signal CSI-RS; and
the determining module is specifically adapted to:
determine the first array based on the second configuration information.

Optionally, the configuration module 1001 is specifically adapted to:
determine a configuration parameter of a CSI-RS based on the predetermined first array; and
configure the first resource based on the configuration parameter of the CSI-RS.

Optionally, the first configuration information includes at least one of the following:
structure indication information of a Costas array;
order indication information of a Costas array;
type indication information of a Costas array;
generation method indication information of a Costas array;
generation parameter indication information of a Costas array;
index indication information of a Costas array;
resource mapping granularity indication information of a Costas array; and
a configuration parameter of a time-frequency resource position of a Costas array.

Optionally, the configuration parameter of the time-frequency resource position of the Costas array includes at least one of the following:
a start frequency of the first signal;
start time of the first signal;
a total width of a frequency domain of the first signal;
total duration of the first signal;
a first frequency offset, used for indicating an offset of a start frequency of a Costas array relative to the start frequency of the first signal;
a first time offset, used for indicating an offset of start time of a Costas array relative to the start time of the first signal;
a second frequency offset, used for indicating an offset of a start frequency of a Costas array set to which a Costas array belongs relative to the start frequency of the first signal;
a second time offset, used for indicating an offset of start time of a Costas array set to which a Costas array belongs relative to the start time of the first signal;
a third frequency offset, used for indicating an offset of a start frequency of a Costas array relative to a start frequency of a Costas array set to which the Costas array belongs;
a third time offset, used for indicating an offset of start time of a Costas array relative to start time of a Costas array set to which the Costas array belongs;
a first frequency domain cycle, used for indicating a frequency domain interval between adjacent Costas arrays;
a first time domain cycle, used for indicating a time domain interval between adjacent Costas arrays;
a second frequency domain cycle, used for indicating a frequency domain interval between adjacent Costas array sets;
a second time domain cycle, used for indicating a time domain interval between adjacent Costas array sets;
a quantity of frequency-domain Costas arrays, used for indicating a quantity of Costas arrays included in each Costas array set in the frequency domain;
a quantity of time-domain Costas arrays, used for indicating a quantity of Costas arrays included in each Costas array set in the time domain;
a quantity of frequency-domain Costas array sets, used for indicating a quantity of Costas array sets in the frequency domain;
a quantity of time-domain Costas array sets, used for indicating a quantity of Costas array sets in the time domain;
a modulation sequence parameter of a Costas array;
a muted time position in a Costas array; and
quasi co-location information between a time-frequency resource in which a Costas array is located and another reference signal.

Optionally, the generation parameter indication information includes at least one of the following:
a prime number used for generating a Costas array;
a primitive element of a finite field used for generating a Costas array;
a non-zero element of a finite field used for generating a Costas array; and
a power of a prime number used for generating a Costas array.

In conclusion, a resource sequence of a first resource configured based on the Costas array has a “pin-shaped” ambiguity function. The first signal is sent by using the first resource, so that a main peak of the first signal is high and sharp, a sub-peak is low and flat, and a signal resolution is high. It can be learned that signal sensing performance can be improved according to this embodiment of this application.

The resource configuration apparatus 1000 in the embodiments of this application may be an electronic device, for example, an electronic device having an operating system, or may be a component, for example, an integrated circuit or a chip in an electronic device. The electronic device may be the terminal, or may be a device other than the terminal. In an example, the terminal may include, but is not limited to, the above listed types of the terminal 11, and the another device may be a server, a network attached storage (Network Attached Storage, NAS), or the like. This is not specifically limited in the embodiments of this application.

The resource configuration apparatus 1000 provided in this embodiment of this application can implement various processes implemented in the method embodiments of FIG. 2 to FIG. 9, and the same technical effects can be achieved. This is not described herein again to avoid repetition.

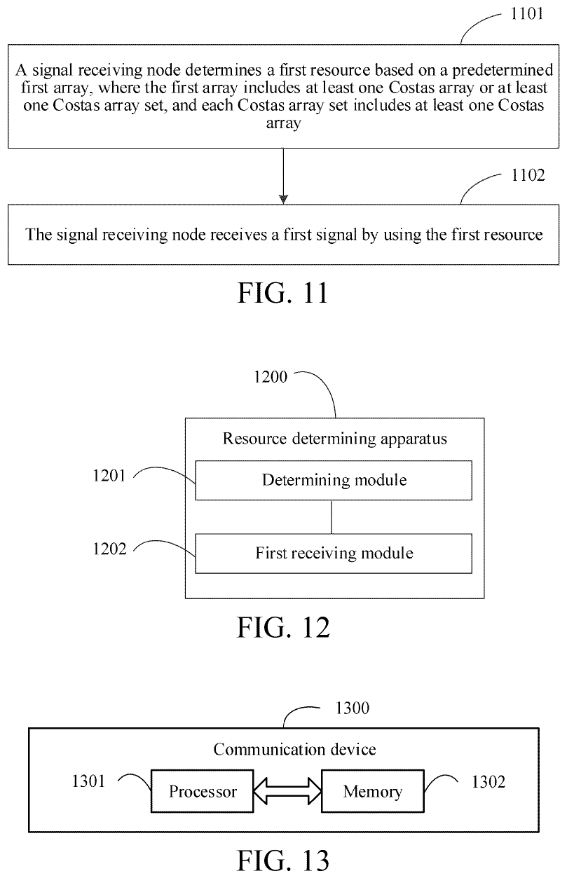

FIG. 11 is a flowchart of a resource determining method according to an embodiment of this application. As shown in FIG. 11, the resource determining method includes the following steps.
Step 1101: A signal receiving node determines a first resource based on a predetermined first array, where the first array includes at least one Costas array or at least one Costas array set, and each Costas array set includes at least one Costas array.
Step 1101: The signal receiving node receives a first signal by using the first resource.

Optionally, the first signal is a signal related to a sensing service or an integrated sensing and communication service.

Optionally, the method further includes:
in a case in which an available resource of the signal receiving node is greater than the first resource, the signal receiving node transmits a second signal by using a resource other than the first resource in the available resource, where the second signal is a signal related to a communication service.

Optionally, before that a signal receiving node determines a first resource based on a predetermined first array, the method further includes:
the signal receiving node determines the first array.

Optionally, that the signal receiving node determines the first array includes:
the signal receiving node determines a structure of the first array and a position of a time-frequency resource to which the first array is mapped.

Optionally, that the signal receiving node determines a structure of the first array includes any one of the following:
the signal receiving node determines the structure of the first array based on an algebraic construction method; and
the signal receiving node determines the structure of the first array based on a look-up table method.

Optionally, that the signal receiving node determines a structure of the first array includes:
the signal receiving node determines the structure of the first array based on at least one of the following: order indication information of a Costas array, type indication information of a Costas array, a prime number of a Costas array, a primitive element of a finite field of a Costas array, a non-zero element of a finite field of a Costas array, a power of a prime number of a Costas array, resource mapping granularity indication information of a Costas array, a Costas array set index, and a Costas array index.

Optionally, that the signal receiving node determines a position of a time-frequency resource to which the first array is mapped includes:
the signal receiving node determines, based on a start frequency of the first signal, start time of the first signal, a frequency offset of the first array, and a time offset of the first array, the position of the time-frequency resource to which the first array is mapped.

Optionally, in a case in which the first array includes at least two Costas arrays or includes at least two Costas array sets, the first array includes at least one of the following:
at least two Costas arrays arranged at an interval in a frequency domain;
at least two Costas arrays arranged at an interval in a time domain;
at least two Costas array sets arranged at an interval in the frequency domain; and
at least two Costas array sets arranged at an interval in the time domain.

Optionally, the at least two Costas arrays have a same order and structure; or
the at least two Costas arrays have a same order and different structures; or
the at least two Costas arrays have different orders and structures.

Optionally, after that a signal receiving node configures a first resource based on a predetermined first array, the method further includes:
the signal receiving node performs a first operation in a case in which the first resource conflicts with a transmission resource of a third signal, where
the third signal is a signal related to the communication service, and the first operation includes any one of the following:
the signal receiving node sends the first signal at a conflicting resource position of the first array by using a regenerated second array, where the second array includes at least one Costas array or at least one Costas array set;
the signal receiving node sends the first signal at the conflicting resource position of the first array by using a neighboring non-conflicting resource position;
the signal receiving node sends the first signal at the conflicting resource position of the first array by using a third array, where a resource to which the third array is mapped does not conflict with the transmission resource of the third signal, and the third array includes at least one of a quadratic congruence array, a cubic congruence array, and a discrete linear frequency modulation array; and
the signal receiving node cancels sending of the first signal at the conflicting resource position of the first array.

Optionally, after that the signal receiving node determines the first array, the method further includes:
the signal receiving node modulates the first array by using a preset mapping symbol sequence, where the mapping symbol sequence includes at least one of an all 1s sequence, a Zadoff-Chu sequence, an m sequence, and a Gold sequence.

Optionally, the Costas array includes at least one of a Welch-Costas array, a Golomb-Costas array, and a Lempel-Costas array.

Optionally, that the signal receiving node determines the first array includes:
the signal receiving node receives first configuration information, where the first configuration information is used for configuring the first signal; and
the signal receiving node determines the first array based on the first configuration information.

Optionally, that the signal receiving node determines the first array includes:
the signal receiving node receives second configuration information, where the second configuration information is used for configuring a channel state information reference signal CSI-RS; and
the signal receiving node determines the first array based on the second configuration information.

Optionally, that a signal receiving node configures a first resource based on a predetermined first array includes:
the signal receiving node determines a configuration parameter of a CSI-RS based on the predetermined first array; and
the signal receiving node configures the first resource based on the configuration parameter of the CSI-RS.

Optionally, the first configuration information includes at least one of the following:
structure indication information of a Costas array;
order indication information of a Costas array;
type indication information of a Costas array;
generation method indication information of a Costas array;
generation parameter indication information of a Costas array;
index indication information of a Costas array;
resource mapping granularity indication information of a Costas array; and
a configuration parameter of a time-frequency resource position of a Costas array.

Optionally, the configuration parameter of the time-frequency resource position of the Costas array includes at least one of the following:
a start frequency of the first signal;
start time of the first signal;
a total width of a frequency domain of the first signal;
total duration of the first signal;
a first frequency offset, used for indicating an offset of a start frequency of a Costas array relative to the start frequency of the first signal;
a first time offset, used for indicating an offset of start time of a Costas array relative to the start time of the first signal;
a second frequency offset, used for indicating an offset of a start frequency of a Costas array set to which a Costas array belongs relative to the start frequency of the first signal;
a second time offset, used for indicating an offset of start time of a Costas array set to which a Costas array belongs relative to the start time of the first signal;
a third frequency offset, used for indicating an offset of a start frequency of a Costas array relative to a start frequency of a Costas array set to which the Costas array belongs;
a third time offset, used for indicating an offset of start time of a Costas array relative to start time of a Costas array set to which the Costas array belongs;
a first frequency domain cycle, used for indicating a frequency domain interval between adjacent Costas arrays;
a first time domain cycle, used for indicating a time domain interval between adjacent Costas arrays;
a second frequency domain cycle, used for indicating a frequency domain interval between adjacent Costas array sets;
a second time domain cycle, used for indicating a time domain interval between adjacent Costas array sets;
a quantity of frequency-domain Costas arrays, used for indicating a quantity of Costas arrays included in each Costas array set in the frequency domain;
a quantity of time-domain Costas arrays, used for indicating a quantity of Costas arrays included in each Costas array set in the time domain;
a quantity of frequency-domain Costas array sets, used for indicating a quantity of Costas array sets in the frequency domain;
a quantity of time-domain Costas array sets, used for indicating a quantity of Costas array sets in the time domain;
a modulation sequence parameter of a Costas array;
a muted time position in a Costas array; and
quasi co-location information between a time-frequency resource in which a Costas array is located and another reference signal.

Optionally, the generation parameter indication information includes at least one of the following:
a prime number used for generating a Costas array;
a primitive element of a finite field used for generating a Costas array;
a non-zero element of a finite field used for generating a Costas array; and
a power of a prime number used for generating a Costas array.

In conclusion, a resource sequence of a first resource determined based on the Costas array has a “pin-shaped” ambiguity function. The first signal is received by using the first resource, so that a main peak of the first signal is high and sharp, a sub-peak is low and flat, and a signal resolution is high. It can be learned that signal sensing performance can be improved according to this embodiment of this application.

For the resource determining method provided in the embodiments of this application, an execution body may be a resource determining apparatus. In the embodiments of this application, an example in which the resource determining apparatus executes the resource determining method is used to describe the resource determining apparatus provided in the embodiments of this application.

Referring to FIG. 12, an embodiment of this application further provides a resource determining apparatus, which may be used for a signal receiving node. As shown in FIG. 12, a resource determining apparatus 1200 includes:
a determining module 1201, adapted to determine a first resource based on a predetermined first array, where the first array includes at least one Costas array or at least one Costas array set, and each Costas array set includes at least one Costas array; and
a first receiving module 1202, adapted to receive a first signal by using the first resource.

Optionally, the first signal is a signal related to a sensing service or an integrated sensing and communication service.

Optionally, the resource determining apparatus 1200 further includes:
a transmission module, adapted to transmit, in a case in which an available resource of the signal receiving node is greater than the first resource, a second signal by using a resource other than the first resource in the available resource, where the second signal is a signal related to a communication service.

Optionally, the resource determining apparatus 1200 further includes:
a determining module, adapted to determine the first array.

Optionally, the determining module is specifically adapted to:
determine a structure of the first array and a position of a time-frequency resource to which the first array is mapped.

Optionally, the determining module is specifically adapted to performing any one of the following:
determining the structure of the first array based on an algebraic construction method; or
determining the structure of the first array based on a look-up table method.

Optionally, the determining module is specifically adapted to:
determine the structure of the first array based on at least one of the following: order indication information of a Costas array, type indication information of a Costas array, a prime number of a Costas array, a primitive element of a finite field of a Costas array, a non-zero element of a finite field of a Costas array, a power of a prime number of a Costas array, resource mapping granularity indication information of a Costas array, a Costas array set index, and a Costas array index.

Optionally, the determining module is specifically adapted to:
determine, based on a start frequency of the first signal, start time of the first signal, a frequency offset of the first array, and a time offset of the first array, the position of the time-frequency resource to which the first array is mapped.

Optionally, in a case in which the first array includes at least two Costas arrays or includes at least two Costas array sets, the first array includes at least one of the following:
at least two Costas arrays arranged at an interval in a frequency domain;
at least two Costas arrays arranged at an interval in a time domain;
at least two Costas array sets arranged at an interval in the frequency domain; and
at least two Costas array sets arranged at an interval in the time domain.

Optionally, the at least two Costas arrays have a same order and structure; or
the at least two Costas arrays have a same order and different structures; or
the at least two Costas arrays have different orders and structures.

Optionally, the resource determining apparatus 1200 further includes:
a performing module, adapted to perform a first operation in a case in which the first resource conflicts with a transmission resource of a third signal, where
the third signal is a signal related to the communication service, and the performing module is specifically adapted to perform any one of the following:
sending the first signal at a conflicting resource position of the first array by using a regenerated second array, where the second array includes at least one Costas array or at least one Costas array set;
sending the first signal at the conflicting resource position of the first array by using a neighboring non-conflicting resource position;
sending the first signal at the conflicting resource position of the first array by using a third array, where a resource to which the third array is mapped does not conflict with the transmission resource of the third signal, and the third array includes at least one of a quadratic congruence array, a cubic congruence array, and a discrete linear frequency modulation array; and
canceling sending of the first signal at the conflicting resource position of the first array.

Optionally, the resource determining apparatus 1200 further includes:
a modulation module, adapted to modulate the first array by using a preset mapping symbol sequence, where the mapping symbol sequence includes at least one of an all 1s sequence, a Zadoff-Chu sequence, an m sequence, and a Gold sequence.

Optionally, the Costas array includes at least one of a Welch-Costas array, a Golomb-Costas array, and a Lempel-Costas array.

Optionally, the resource determining apparatus 1200 further includes:
a second receiving module, adapted to receive first configuration information, where the first configuration information is used for configuring the first signal; and
the determining module is specifically adapted to:

determine the first array based on the first configuration information.

Optionally, the resource determining apparatus 1200 further includes:
a third receiving module, adapted to receive second configuration information, where the second configuration information is used for configuring a channel state information reference signal CSI-RS; and
the determining module is specifically adapted to:
determine the first array based on the second configuration information.

Optionally, the determining module is specifically adapted to:
determine a configuration parameter of a CSI-RS based on the predetermined first array; and
configure the first resource based on the configuration parameter of the CSI-RS.

Optionally, the first configuration information includes at least one of the following:
structure indication information of a Costas array;
order indication information of a Costas array;
type indication information of a Costas array;
generation method indication information of a Costas array;
generation parameter indication information of a Costas array;
index indication information of a Costas array;
resource mapping granularity indication information of a Costas array; and
a configuration parameter of a time-frequency resource position of a Costas array.

Optionally, the configuration parameter of the time-frequency resource position of the Costas array includes at least one of the following:
a start frequency of the first signal;
start time of the first signal;
a total width of a frequency domain of the first signal;
total duration of the first signal;
a first frequency offset, used for indicating an offset of a start frequency of a Costas array relative to the start frequency of the first signal;
a first time offset, used for indicating an offset of start time of a Costas array relative to the start time of the first signal;
a second frequency offset, used for indicating an offset of a start frequency of a Costas array set to which a Costas array belongs relative to the start frequency of the first signal;
a second time offset, used for indicating an offset of start time of a Costas array set to which a Costas array belongs relative to the start time of the first signal;
a third frequency offset, used for indicating an offset of a start frequency of a Costas array relative to a start frequency of a Costas array set to which the Costas array belongs;
a third time offset, used for indicating an offset of start time of a Costas array relative to start time of a Costas array set to which the Costas array belongs;
a first frequency domain cycle, used for indicating a frequency domain interval between adjacent Costas arrays;
a first time domain cycle, used for indicating a time domain interval between adjacent Costas arrays;
a second frequency domain cycle, used for indicating a frequency domain interval between adjacent Costas array sets;
a second time domain cycle, used for indicating a time domain interval between adjacent Costas array sets;
a quantity of frequency-domain Costas arrays, used for indicating a quantity of Costas arrays included in each Costas array set in the frequency domain;
a quantity of time-domain Costas arrays, used for indicating a quantity of Costas arrays included in each Costas array set in the time domain;
a quantity of frequency-domain Costas array sets, used for indicating a quantity of Costas array sets in the frequency domain;
a quantity of time-domain Costas array sets, used for indicating a quantity of Costas array sets in the time domain;
a modulation sequence parameter of a Costas array;
a muted time position in a Costas array; and
quasi co-location information between a time-frequency resource in which a Costas array is located and another reference signal.

Optionally, the generation parameter indication information includes at least one of the following:
a prime number used for generating a Costas array;
a primitive element of a finite field used for generating a Costas array;
a non-zero element of a finite field used for generating a Costas array; and
a power of a prime number used for generating a Costas array.

In conclusion, a resource sequence of a first resource determined based on the Costas array has a “pin-shaped” ambiguity function. The first signal is received by using the first resource, so that a main peak of the first signal is high and sharp, a sub-peak is low and flat, and a signal resolution is high. It can be learned that signal sensing performance can be improved according to this embodiment of this application.

The resource determining apparatus 1200 in the embodiments of this application may be an electronic device, for example, an electronic device having an operating system, or may be a component, for example, an integrated circuit or a chip in an electronic device. The electronic device may be a terminal, or may be a device other than the terminal. In an example, the terminal may include, but is not limited to, the above listed types of the terminal 11, and the another device may be a server, a network attached storage (Network Attached Storage, NAS), or the like. This is not specifically limited in the embodiments of this application.

The resource determining apparatus 1200 provided in this embodiment of this application can implement the processes implemented in the method embodiment of FIG. 11 and achieve the same technical effects. To avoid repetition, details are not described herein again.

Optionally, as shown in FIG. 13, an embodiment of this application further provides a communication device 1300, including a processor 1301 and a memory 1302. The memory 1302 stores a program or instructions runnable on the processor 1301. For example, when the communication device 1300 is a terminal, the program or instructions, when executed by the processor 1301, implement the steps of the embodiments of the resource configuration method, and can achieve the same technical effect. When the communication device 1300 is a network side device, the program or the instructions, when executed by the processor 1301, implement the steps of the embodiments of the resource determining method, and can achieve the same technical effect. To avoid repetition, details are not described herein again.

An embodiment of this application further provides a signal sending node. The signal sending node is a terminal or a network side device, and the signal sending node includes a processor and a communication interface. The processor is adapted to configure a first resource based on a predetermined first array, where the first array includes at least one Costas array or at least one Costas array set, and each Costas array set includes at least one Costas array. The communication interface is adapted to send a first signal by using the first resource.

An embodiment of this application further provides a signal receiving node. The signal receiving node is a terminal or a network side device, and the signal receiving node includes a processor and a communication interface. The processor is adapted to determine a first resource based on a predetermined first array, where the first array includes at least one Costas array or at least one Costas array set, and each Costas array set includes at least one Costas array. The communication interface is configured to receive a first signal by using the first resource.

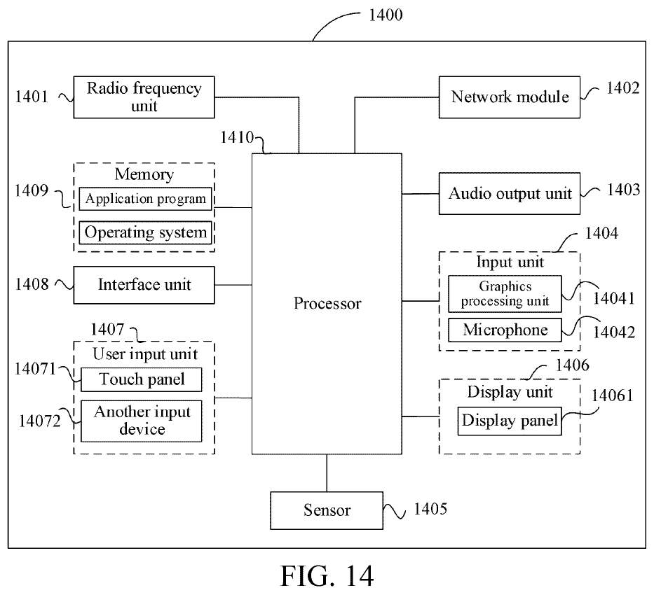

Each implementation process and implementation method in the method embodiments can be applied to the terminal, and the same technical effect can be achieved. Specifically, FIG. 14 is a schematic diagram of a hardware structure of a terminal implementing an embodiment of this application.

The terminal 1400 includes, but is not limited to: at least some of the following components: a radio frequency unit 1401, a network module 1402, an audio output unit 1403, an input unit 1404, a sensor 1405, a display unit 1406, a user input unit 1407, an interface unit 1408, a memory 1409, a processor 1410, and the like.

A person skilled in the art can understand that the terminal 1400 may further include a power supply (such as a battery) for supplying power to the components. The power supply may be logically connected to the processor 1410 through a power management system, to implement functions such as charging management, discharging management, and power consumption management through the power management system. A terminal structure shown in FIG. 14 does not constitute a limitation to the terminal, and the terminal may include more or fewer components than those shown in the figure, or some components may be combined, or a different component deployment may be used, and details are not repeated herein.

It should be understood that the input unit 1404 may include a graphics processing unit (Graphics Processing Unit, GPU) 14041 and a microphone 14042 in this embodiment of this application. The GPU 14041 processes image data of a still picture or a video that are obtained by an image capture apparatus (for example, a camera) in a video capture mode or an image capture mode. The display unit 1406 may include a display panel 14061, which may be configured in a form of a liquid crystal display, an organic light-emitting diode, or the like. The user input unit 1407 includes a touch panel 14071 and at least one another input device 14072. The touch panel 14071 is also referred to as a touch screen. The touch panel 14071 may include two parts: a touch detection apparatus and a touch controller. Another input device 14072 may include, but is not limited to, a physical keyboard, a functional key (such as a volume control key or a switch key), a track ball, a mouse, and a joystick. Details are not described herein again.

In this embodiment of this application, after receiving downlink data from a network side device, the radio frequency unit 1401 may transmit the data to the processor 1410 for processing. In addition, the radio frequency unit 1401 may send uplink data to the network side device. Generally, the radio frequency unit 1401 includes, but is not limited to, an antenna, an amplifier, a transceiver, a coupler, a low-noise amplifier, a duplexer, and the like.

The memory 1409 may be configured to store a software program or instructions, and various data. The memory 1409 may mainly include a first storage area for storing the program or the instructions and a second storage area for storing the data. The first storage area may store an operating system, an application program or instructions (such as an audio play function and an image play function) required by at least one function, and the like. In addition, the memory 1409 may include a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus dynamic random access memory (Direct Rambus RAM, DRRAM). The memory 1409 in this embodiment of this application includes, but is not limited to, these memories and any other suitable types of memories.

The processor 1410 may include one or more processing units. Optionally, the processor 1410 integrates an application processor and a modem. The application processor mainly processes operations related to an operating system, a user interface, an application program, and the like. The modem mainly processes a wireless communication signal, such as a baseband processor. It may be understood that, the modem may not be integrated into the processor 1410.

The terminal 1400 may be used as a signal sending node to perform the steps of the resource configuration method in the embodiments of this application, and may be used as a signal receiving node to perform the steps of the resource determining method in the embodiments of this application.

In one aspect, the terminal 1400 may be used as a signal sending node to perform the following steps:

The processor 1410 is adapted to configure a first resource based on a predetermined first array, where the first array includes at least one Costas array or at least one Costas array set, and each Costas array set includes at least one Costas array.

The radio frequency unit 1401 is adapted to send a first signal by using the first resource.

Optionally, the first signal is a signal related to a sensing service or an integrated sensing and communication service.

Optionally, the radio frequency unit 1401 is adapted to:
transmit, in a case in which an available resource of the signal sending node is greater than the first resource, a second signal by using a resource other than the first resource in the available resource, where the second signal is a signal related to a communication service.

Optionally, the processor 1410 is further adapted to:
determine the first array.

Optionally, the processor 1410 is further adapted to:
determine a structure of the first array and a position of a time-frequency resource to which the first array is mapped.

Optionally, the processor 1410 is further adapted to performing any one of the following:
determining the structure of the first array based on an algebraic construction method; or
determining the structure of the first array based on a look-up table method.

Optionally, the processor 1410 is further adapted to:
determine the structure of the first array based on at least one of the following: order indication information of a Costas array, type indication information of a Costas array, a prime number of a Costas array, a primitive element of a finite field of a Costas array, a non-zero element of a finite field of a Costas array, a power of a prime number of a Costas array, resource mapping granularity indication information of a Costas array, a Costas array set index, and a Costas array index.

Optionally, the processor 1410 is further adapted to:
determine, based on a start frequency of the first signal, start time of the first signal, a frequency offset of the first array, and a time offset of the first array, the position of the time-frequency resource to which the first array is mapped.

Optionally, in a case in which the first array includes at least two Costas arrays or includes at least two Costas array sets, the first array includes at least one of the following:
at least two Costas arrays arranged at an interval in a frequency domain;
at least two Costas arrays arranged at an interval in a time domain;
at least two Costas array sets arranged at an interval in the frequency domain; and
at least two Costas array sets arranged at an interval in the time domain.

Optionally, the at least two Costas arrays have a same order and structure; or
the at least two Costas arrays have a same order and different structures; or
the at least two Costas arrays have different orders and structures.

Optionally, the processor 1410 is further adapted to:
perform a first operation in a case in which the first resource conflicts with a transmission resource of a third signal, where
the third signal is a signal related to the communication service, and the first operation specifically includes any one of the following:
sending the first signal at a conflicting resource position of the first array by using a regenerated second array, where the second array includes at least one Costas array or at least one Costas array set;
sending the first signal at the conflicting resource position of the first array by using a neighboring non-conflicting resource position;
sending the first signal at the conflicting resource position of the first array by using a third array, where a resource to which the third array is mapped does not conflict with the transmission resource of the third signal, and the third array includes at least one of a quadratic congruence array, a cubic congruence array, and a discrete linear frequency modulation array; and
canceling sending of the first signal at the conflicting resource position of the first array.

Optionally, the processor 1410 is further adapted to:
modulate the first array by using a preset mapping symbol sequence, where the mapping symbol sequence includes at least one of an all 1s sequence, a Zadoff-Chu sequence, an m sequence, and a Gold sequence.

Optionally, the Costas array includes at least one of a Welch-Costas array, a Golomb-Costas array, and a Lempel-Costas array.

Optionally, the radio frequency unit 1401 is further adapted to:
receive first configuration information, where the first configuration information is used for configuring the first signal.

The processor 1410 is further adapted to:
determine the first array based on the first configuration information.

Optionally, the radio frequency unit 1401 is further adapted to:
receive second configuration information, where the second configuration information is used for configuring a channel state information reference signal CSI-RS.

The processor 1410 is further adapted to:
determine the first array based on the second configuration information.

Optionally, the processor 1410 is further adapted to:
determine a configuration parameter of a CSI-RS based on the predetermined first array; and
configure the first resource based on the configuration parameter of the CSI-RS.

Optionally, the first configuration information includes at least one of the following:
structure indication information of a Costas array;
order indication information of a Costas array;
type indication information of a Costas array;
generation method indication information of a Costas array;
generation parameter indication information of a Costas array;
index indication information of a Costas array;
resource mapping granularity indication information of a Costas array; and
a configuration parameter of a time-frequency resource position of a Costas array.

Optionally, the configuration parameter of the time-frequency resource position of the Costas array includes at least one of the following:
a start frequency of the first signal;
start time of the first signal;
a total width of a frequency domain of the first signal;
total duration of the first signal;
a first frequency offset, used for indicating an offset of a start frequency of a Costas array relative to the start frequency of the first signal;
a first time offset, used for indicating an offset of start time of a Costas array relative to the start time of the first signal;
a second frequency offset, used for indicating an offset of a start frequency of a Costas array set to which a Costas array belongs relative to the start frequency of the first signal;
a second time offset, used for indicating an offset of start time of a Costas array set to which a Costas array belongs relative to the start time of the first signal;
a third frequency offset, used for indicating an offset of a start frequency of a Costas array relative to a start frequency of a Costas array set to which the Costas array belongs;
a third time offset, used for indicating an offset of start time of a Costas array relative to start time of a Costas array set to which the Costas array belongs;
a first frequency domain cycle, used for indicating a frequency domain interval between adjacent Costas arrays;
a first time domain cycle, used for indicating a time domain interval between adjacent Costas arrays;
a second frequency domain cycle, used for indicating a frequency domain interval between adjacent Costas array sets;
a second time domain cycle, used for indicating a time domain interval between adjacent Costas array sets;
a quantity of frequency-domain Costas arrays, used for indicating a quantity of Costas arrays included in each Costas array set in the frequency domain;
a quantity of time-domain Costas arrays, used for indicating a quantity of Costas arrays included in each Costas array set in the time domain;
a quantity of frequency-domain Costas array sets, used for indicating a quantity of Costas array sets in the frequency domain;
a quantity of time-domain Costas array sets, used for indicating a quantity of Costas array sets in the time domain;
a modulation sequence parameter of a Costas array;
a muted time position in a Costas array; and
quasi co-location information between a time-frequency resource in which a Costas array is located and another reference signal.

Optionally, the generation parameter indication information includes at least one of the following:
a prime number used for generating a Costas array;
a primitive element of a finite field used for generating a Costas array;
a non-zero element of a finite field used for generating a Costas array; and
a power of a prime number used for generating a Costas array.

In another aspect, the terminal 1400 may be used as a signal receiving node to perform the following steps:

The processor 1410 is adapted to:
determine a first resource based on a predetermined first array, where the first array includes at least one Costas array or at least one Costas array set, and each Costas array set includes at least one Costas array.

The radio frequency unit 1401 is adapted to:
receive a first signal by using the first resource.

Optionally, the first signal is a signal related to a sensing service or an integrated sensing and communication service.

Optionally, the radio frequency unit 1401 is adapted to:
transmit, in a case in which an available resource of the signal receiving node is greater than the first resource, a second signal by using a resource other than the first resource in the available resource, where the second signal is a signal related to a communication service.

Optionally, the processor 1410 is further adapted to:
determine the first array.

Optionally, the processor 1410 is further adapted to:
determine a structure of the first array and a position of a time-frequency resource to which the first array is mapped.

Optionally, the processor 1410 is further adapted to performing any one of the following:
determining the structure of the first array based on an algebraic construction method; or
determining the structure of the first array based on a look-up table method.

Optionally, the processor 1410 is further adapted to:
determine the structure of the first array based on at least one of the following: order indication information of a Costas array, type indication information of a Costas array, a prime number of a Costas array, a primitive element of a finite field of a Costas array, a non-zero element of a finite field of a Costas array, a power of a prime number of a Costas array, resource mapping granularity indication information of a Costas array, a Costas array set index, and a Costas array index.

Optionally, the processor 1410 is further adapted to:
determine, based on a start frequency of the first signal, start time of the first signal, a frequency offset of the first array, and a time offset of the first array, the position of the time-frequency resource to which the first array is mapped.

Optionally, in a case in which the first array includes at least two Costas arrays or includes at least two Costas array sets, the first array includes at least one of the following:
at least two Costas arrays arranged at an interval in a frequency domain;
at least two Costas arrays arranged at an interval in a time domain;
at least two Costas array sets arranged at an interval in the frequency domain; and
at least two Costas array sets arranged at an interval in the time domain.

Optionally, the at least two Costas arrays have a same order and structure; or
the at least two Costas arrays have a same order and different structures; or
the at least two Costas arrays have different orders and structures.

Optionally, the processor 1410 is further adapted to:
perform a first operation in a case in which the first resource conflicts with a transmission resource of a third signal, where
the third signal is a signal related to the communication service, and the first operation specifically includes any one of the following:
sending the first signal at a conflicting resource position of the first array by using a regenerated second array, where the second array includes at least one Costas array or at least one Costas array set;
sending the first signal at the conflicting resource position of the first array by using a neighboring non-conflicting resource position;
sending the first signal at the conflicting resource position of the first array by using a third array, where a resource to which the third array is mapped does not conflict with the transmission resource of the third signal, and the third array includes at least one of a quadratic congruence array, a cubic congruence array, and a discrete linear frequency modulation array; and
canceling sending of the first signal at the conflicting resource position of the first array.

Optionally, the processor 1410 is further adapted to:
modulate the first array by using a preset mapping symbol sequence, where the mapping symbol sequence includes at least one of an all 1s sequence, a Zadoff-Chu sequence, an m sequence, and a Gold sequence.

Optionally, the Costas array includes at least one of a Welch-Costas array, a Golomb-Costas array, and a Lempel-Costas array.

Optionally, the radio frequency unit 1401 is further adapted to:
receive first configuration information, where the first configuration information is used for configuring the first signal.
the processor 1410 is further adapted to:
determine the first array based on the first configuration information.

Optionally, the radio frequency unit 1401 is further adapted to:
receive second configuration information, where the second configuration information is used for configuring a channel state information reference signal CSI-RS.

The processor 1410 is further adapted to:
determine the first array based on the second configuration information.

Optionally, the processor 1410 is further adapted to:
determine a configuration parameter of a CSI-RS based on the predetermined first array; and
configure the first resource based on the configuration parameter of the CSI-RS.

Optionally, the first configuration information includes at least one of the following:
structure indication information of a Costas array;
order indication information of a Costas array;
type indication information of a Costas array;
generation method indication information of a Costas array;
generation parameter indication information of a Costas array;
index indication information of a Costas array;
resource mapping granularity indication information of a Costas array; and
a configuration parameter of a time-frequency resource position of a Costas array.

Optionally, the configuration parameter of the time-frequency resource position of the Costas array includes at least one of the following:
a start frequency of the first signal;
start time of the first signal;
a total width of a frequency domain of the first signal;
total duration of the first signal;
a first frequency offset, used for indicating an offset of a start frequency of a Costas array relative to the start frequency of the first signal;
a first time offset, used for indicating an offset of start time of a Costas array relative to the start time of the first signal;
a second frequency offset, used for indicating an offset of a start frequency of a Costas array set to which a Costas array belongs relative to the start frequency of the first signal;
a second time offset, used for indicating an offset of start time of a Costas array set to which a Costas array belongs relative to the start time of the first signal;
a third frequency offset, used for indicating an offset of a start frequency of a Costas array relative to a start frequency of a Costas array set to which the Costas array belongs;
a third time offset, used for indicating an offset of start time of a Costas array relative to start time of a Costas array set to which the Costas array belongs;
a first frequency domain cycle, used for indicating a frequency domain interval between adjacent Costas arrays;
a first time domain cycle, used for indicating a time domain interval between adjacent Costas arrays;
a second frequency domain cycle, used for indicating a frequency domain interval between adjacent Costas array sets;
a second time domain cycle, used for indicating a time domain interval between adjacent Costas array sets;
a quantity of frequency-domain Costas arrays, used for indicating a quantity of Costas arrays included in each Costas array set in the frequency domain;
a quantity of time-domain Costas arrays, used for indicating a quantity of Costas arrays included in each Costas array set in the time domain;
a quantity of frequency-domain Costas array sets, used for indicating a quantity of Costas array sets in the frequency domain;
a quantity of time-domain Costas array sets, used for indicating a quantity of Costas array sets in the time domain;
a modulation sequence parameter of a Costas array;
a muted time position in a Costas array; and
quasi co-location information between a time-frequency resource in which a Costas array is located and another reference signal.

Optionally, the generation parameter indication information includes at least one of the following:
a prime number used for generating a Costas array;
a primitive element of a finite field used for generating a Costas array;
a non-zero element of a finite field used for generating a Costas array; and
a power of a prime number used for generating a Costas array.

In conclusion, a resource sequence of a first resource configured based on the Costas array has a “pin-shaped” ambiguity function. The first signal is sent by using the first resource, so that a main peak of the first signal is high and sharp, a sub-peak is low and flat, and a signal resolution is high. It can be learned that signal sensing performance can be improved according to this embodiment of this application.

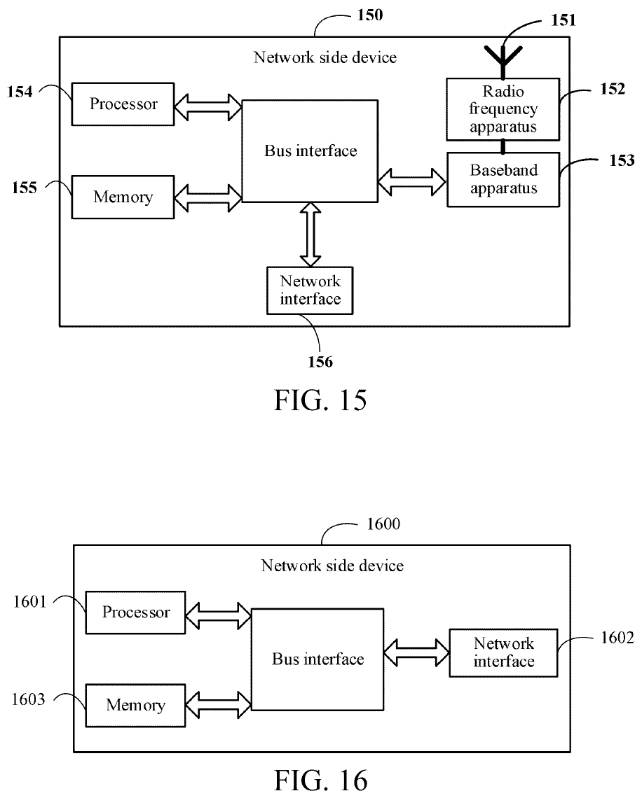

Each implementation process and implementation method in the method embodiments can be further applied to the network side device, and the same technical effect can be achieved. Specifically, FIG. 15 is a schematic diagram of a hardware structure of a network side device according to an embodiment of this application. As shown in FIG. 15, the network side device 150 includes: an antenna 151, a radio frequency apparatus 152, a baseband apparatus 153, a processor 154, and a memory 155. The antenna 151 is connected to the radio frequency apparatus 152. In an uplink direction, the radio frequency apparatus 152 receives information through the antenna 151, and sends the received information to the baseband apparatus 153 for processing. In a downlink direction, the baseband apparatus 153 processes to-be-sent information, and sends the information to the radio frequency apparatus 152; and the radio frequency apparatus 152 processes the received information and then sends the information through the antenna 151.

The method performed by the network side device in the foregoing embodiments may be implemented in the baseband apparatus 153, and the baseband apparatus 153 includes a baseband processor.

The baseband apparatus 153 may include, for example, at least one baseband board. A plurality of chips are arranged on the baseband board. As shown in FIG. 15, a chip is, for example, a baseband processor, and is connected to the memory 155 through a bus interface to invoke a program in the memory 155, to perform operations of a network device shown in the foregoing method embodiments.

The network side device may further include a network interface 156, and the interface is, for example, a common public radio interface (common public radio interface, CPRI).

Specifically, the network side device 150 in this embodiment of this application further includes: instructions or a program stored in the memory 155 and runnable on the processor 154, where the processor 154 invokes the instructions or the program in the memory 155 to perform the method performed by the modules shown in FIG. 10 or FIG. 12, and achieve the same technical effects. To avoid repetition, details are not described herein again.

Specifically, an embodiment of this application further provides a network side device. As shown in FIG. 16, the network side device 1600 includes: a processor 1601, a network interface 1602, and a memory 1603. The network interface 1602 is, for example, a common public radio interface (a common public radio interface, CPRI).

Specifically, the network side device 1600 in this embodiment of this application further includes: instructions or a program stored in the memory 1603 and runnable on the processor 1601, where the processor 1601 invokes the instructions or the program in the memory 1603 to perform the method performed by the modules shown in FIG. 10 or FIG. 12, and achieve the same technical effects. To avoid repetition, details are not described herein again.

An embodiment of this application further provides a readable storage medium, storing a program or instructions. The program or instructions, when executed by a processor, implements the processes of the resource configuration method embodiments or implements the processes of the resource determining method embodiments, and can achieve the same technical effects. To avoid repetition, details are not described herein again.

The processor may be a processor in the terminal in the foregoing embodiments. The readable storage medium includes a computer-readable storage medium, for example, a computer read-only memory ROM, a random access memory RAM, a magnetic disk, an optical disk, or the like.

An embodiment of this application further provides a chip. The chip includes a processor and a communication interface. The communication interface is coupled to the processor. The processor is configured to run a program or instructions to implement the processes of the resource configuration method embodiments or implement the processes of the resource determining method embodiments, and can achieve the same technical effects. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a storage medium, and is executed by at least one processor to implement the processes of the resource configuration method embodiments or implement the processes of the resource determining method embodiments, and can achieve the same technical effects. To avoid repetition, details are not described herein again.

An embodiment of this application further provides a communication system, including: a signal sending node and a signal receiving node. The signal sending node may be adapted to perform the steps of the resource configuration method described above, and the signal receiving node may be adapted to perform the steps of the resource determining method described above.

It should be noted that the terms “include”, “comprise”, or any other variations thereof in this specification are intended to cover a non-exclusive inclusion, so that a process, method, article, or apparatus including a series of elements not only includes those elements, but also includes other elements that are not explicitly listed, or also includes elements inherent to such process, method, article, or apparatus. Without more limitations, the elements defined by the sentence “including a . . . ” do not exclude existence of other identical elements in the process, method, article, or apparatus including the elements. Moreover, it should be noted that the scope of the method and apparatus in the implementations of this application is not limited to performing functions in the order shown or discussed, but may include performing functions in a substantially concurrent manner or in reverse order depending on the functionality involved, for example, the method described may be performed in an order different from the described order, and various steps may also be added, omitted, or combined. Moreover, features described with reference to some examples may be combined in other examples.

Through the foregoing descriptions of the implementations, a person skilled in the art can clearly understand that the methods in the foregoing embodiments can be implemented by software plus a necessary general hardware platform, and certainly, can also be implemented by hardware, but in many cases the former is the better implementation. Based on such an understanding, the technical solutions of this application essentially, or the part contributing to the conventional technology may be implemented in a form of a computer software product. The software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings. However, this application is not limited to the foregoing specific implementations. The foregoing specific implementations are only illustrative rather than restrictive. Inspired by this application, a person of ordinary skill in the art can still derive a plurality of variations without departing from the essence of this application and the protection scope of the claims. All these variations shall fall within the protection of this application.

What is claimed is:

1. A resource configuration method, comprising:
configuring, by a signal sending node, a first resource based on a predetermined first array, wherein the first array comprises at least one Costas array or at least one Costas array set, and each Costas array set comprises at least one Costas array; and
sending, by the signal sending node, a first signal by using the first resource.

2. The method according to claim 1, wherein the first signal is a signal related to a sensing service or an integrated sensing and communication service.

3. The method according to claim 1, further comprising:
in a case in which an available resource of the signal sending node is greater than the first resource, transmitting, by the signal sending node, a second signal by using a resource other than the first resource in the available resource, wherein the second signal is a signal related to a communication service.

4. The method according to claim 1, wherein before the configuring, by a signal sending node, a first resource based on a predetermined first array, the method further comprises:
determining, by the signal sending node, the first array.

5. The method according to claim 4, wherein the determining, by the signal sending node, the first array comprises:
determining, by the signal sending node, a structure of the first array and a position of a time-frequency resource to which the first array is mapped.

6. The method according to claim 5, wherein the determining, by the signal sending node, a structure of the first array comprises any one of the following:
determining, by the signal sending node, the structure of the first array based on an algebraic construction method;
determining, by the signal sending node, the structure of the first array based on a look-up table method; or
determining, by the signal sending node, the structure of the first array based on at least one of the following: order indication information of a Costas array, type indication information of a Costas array, a prime number of a Costas array, a primitive element of a finite field of a Costas array, a non-zero element of a finite field of a Costas array, a power of a prime number of a Costas array, resource mapping granularity indication information of a Costas array, a Costas array set index, and a Costas array index.

7. The method according to claim 5, wherein the determining, by the signal sending node, a position of a time-frequency resource to which the first array is mapped comprises:
determining, by the signal sending node based on a start frequency of the first signal, start time of the first signal, a frequency offset of the first array, and a time offset of the first array, the position of the time-frequency resource to which the first array is mapped.

8. The method according to claim 1, wherein in a case in which the first array comprises at least two Costas arrays or comprises at least two Costas array sets, the first array comprises at least one of the following:
at least two Costas arrays arranged at an interval in a frequency domain;
at least two Costas arrays arranged at an interval in a time domain;
at least two Costas array sets arranged at an interval in the frequency domain; and
at least two Costas array sets arranged at an interval in the time domain.

9. The method according to claim 8, wherein the at least two Costas arrays have a same order and structure; or
the at least two Costas arrays have a same order and different structures; or
the at least two Costas arrays have different orders and structures.

10. The method according to claim 1, wherein after the configuring, by a signal sending node, a first resource based on a predetermined first array, the method further comprises:
performing, by the signal sending node, a first operation in a case in which the first resource conflicts with a transmission resource of a third signal, wherein
the third signal is a signal related to a communication service, and the first operation comprises any one of the following:
sending, by the signal sending node, the first signal at a conflicting resource position of the first array by using a regenerated second array, wherein the second array comprises at least one Costas array or at least one Costas array set;
sending, by the signal sending node, the first signal at the conflicting resource position of the first array by using a neighboring non-conflicting resource position;
sending, by the signal sending node, the first signal at the conflicting resource position of the first array by using a third array, wherein a resource to which the third array is mapped does not conflict with the transmission resource of the third signal, and the third array comprises at least one of a quadratic congruence array, a cubic congruence array, and a discrete linear frequency modulation array; and
canceling, by the signal sending node, sending of the first signal at the conflicting resource position of the first array.

11. The method according to claim 4, wherein after the determining, by the signal sending node, the first array, the method further comprises:
modulating, by the signal sending node, the first array by using a preset mapping symbol sequence, wherein the mapping symbol sequence comprises at least one of an all 1s sequence, a Zadoff-Chu sequence, an m sequence, and a Gold sequence.

12. The method according to claim 1, wherein the Costas array comprises at least one of a Welch-Costas array, a Golomb-Costas array, and a Lempel-Costas array.

13. The method according to claim 4, wherein the determining, by the signal sending node, the first array comprises:
receiving, by the signal sending node, first configuration information, wherein the first configuration information is used for configuring the first signal; and determining, by the signal sending node, the first array based on the first configuration information; or
receiving, by the signal sending node, second configuration information, wherein the second configuration information is used for configuring a channel state information reference signal CSI-RS; and determining, by the signal sending node, the first array based on the second configuration information.

14. The method according to claim 1, wherein the configuring, by a signal sending node, a first resource based on a predetermined first array comprises:
determining, by the signal sending node, a configuration parameter of a CSI-RS based on the predetermined first array; and
configuring, by the signal sending node, the first resource based on the configuration parameter of the CSI-RS.

15. The method according to claim 13, wherein the first configuration information comprises at least one of the following:
structure indication information of a Costas array;
order indication information of a Costas array;
type indication information of a Costas array;
generation method indication information of a Costas array;
generation parameter indication information of a Costas array;
index indication information of a Costas array;
resource mapping granularity indication information of a Costas array; and
a configuration parameter of a time-frequency resource position of a Costas array.

16. The method according to claim 15, wherein the configuration parameter of the time-frequency resource position of the Costas array comprises at least one of the following:
a start frequency of the first signal;
start time of the first signal;
a total width of a frequency domain of the first signal;
total duration of the first signal;
a first frequency offset, used for indicating an offset of a start frequency of a Costas array relative to the start frequency of the first signal;
a first time offset, used for indicating an offset of start time of a Costas array relative to the start time of the first signal;
a second frequency offset, used for indicating an offset of a start frequency of a Costas array set to which a Costas array belongs relative to the start frequency of the first signal;
a second time offset, used for indicating an offset of start time of a Costas array set to which a Costas array belongs relative to the start time of the first signal;
a third frequency offset, used for indicating an offset of a start frequency of a Costas array relative to a start frequency of a Costas array set to which the Costas array belongs;
a third time offset, used for indicating an offset of start time of a Costas array relative to start time of a Costas array set to which the Costas array belongs;
a first frequency domain cycle, used for indicating a frequency domain interval between adjacent Costas arrays;
a first time domain cycle, used for indicating a time domain interval between adjacent Costas arrays;
a second frequency domain cycle, used for indicating a frequency domain interval between adjacent Costas array sets;
a second time domain cycle, used for indicating a time domain interval between adjacent Costas array sets;
a quantity of frequency-domain Costas arrays, used for indicating a quantity of Costas arrays comprised in each Costas array set in the frequency domain;
a quantity of time-domain Costas arrays, used for indicating a quantity of Costas arrays comprised in each Costas array set in the time domain;
a quantity of frequency-domain Costas array sets, used for indicating a quantity of Costas array sets in the frequency domain;
a quantity of time-domain Costas array sets, used for indicating a quantity of Costas array sets in the time domain;
a modulation sequence parameter of a Costas array;
a muted time position in a Costas array; and
quasi co-location information between a time-frequency resource in which a Costas array is located and another reference signal.

17. The method according to claim 15, wherein the generation parameter indication information comprises at least one of the following:
a prime number used for generating a Costas array;
a primitive element of a finite field used for generating a Costas array;
a non-zero element of a finite field used for generating a Costas array; and
a power of a prime number used for generating a Costas array.

18. A resource determining method, comprising:
determining, by a signal receiving node, a first resource based on a predetermined first array, wherein the first array comprises at least one Costas array or at least one Costas array set, and each Costas array set comprises at least one Costas array; and
receiving, by the signal receiving node, a first signal by using the first resource.

19. A communication device, comprising a processor and a memory, wherein the memory stores a program or instructions runnable on the processor, and the program or the instructions, when executed by the processor, implement a resource configuration method, the resource configuration method comprising:
configuring, by a signal sending node, a first resource based on a predetermined first array, wherein the first array comprises at least one Costas array or at least one Costas array set, and each Costas array set comprises at least one Costas array; and
sending, by the signal sending node, a first signal by using the first resource.

20. A communication device, comprising a processor and a memory, wherein the memory stores a program or instructions runnable on the processor, and the program or the instructions, when executed by the processor, implement the resource determining method according to claim 18.
